(19) United States
(12) Patent Application Publication
(10) Pub. No.: US 2016/0023350 A1
(43) Pub. Date: Jan. 28, 2016

(54) Gravitational Load Support System

(71) Applicant: SpringActive, Inc., Tempe, AZ (US)

(72) Inventors: Matthew A. Holgate, Chandler, AZ (US); Kevin Hollander, Scottsdale, AZ (US); Nathan Cahill, Tempe, AZ (US)

(73) Assignee: SpringActive, Inc., Tempe, AZ (US)

(21) Appl. No.: 14/877,775

(22) Filed: Oct. 7, 2015

Related U.S. Application Data
(63) Continuation-in-part of application No. 14/214,867, filed on Mar. 15, 2014.
(60) Provisional application No. 61/790,970, filed on Mar. 15, 2013.
(60) Provisional application No. 62/061,453, filed on Oct. 8, 2014.

(51) Int. Cl. B25J 9/00; B25J 9/16

(52) U.S. Cl. CPC B25J 9/0006; B25J 9/1628; B25J 9/1694; Y10S 901/01

(57) ABSTRACT

A load support device has a first link assembly coupled to a load and a first foot of a user. A first damping element is coupled to the first link assembly. The first damping element includes a double acting piston configured to provide uni-directional damping. A first sensor is disposed on a first limb of the user. A physical characteristic of the first limb is measured with the first sensor. A damping constant of the first damping element is selected based on the physical characteristic of the first limb. A second link assembly is coupled to the load and to a second foot of the user. A second damping element is coupled to the second link assembly between the load and the second foot. The load is alternately supported by the first link assembly and damping element and the second link assembly and damping element throughout a gait cycle.

### CLAIM TO DOMESTIC PRIORITY

The present application is a continuation-in-part of U.S. application Ser. No. 14/214,867, filed Mar. 15, 2014, which claims the benefit of U.S. Provisional Application No. 61/790,970, filed Mar. 15, 2013, which applications are incorporated herein by reference. The present application further claims the benefit of U.S. Provisional Application No. 62/061,453, filed Oct. 8, 2014, which application is incorporated herein by reference.

### FIELD OF THE INVENTION

The present invention relates in general to load support systems and, more particularly, to low-power load support systems that allow for substantially unencumbered gait.

### BACKGROUND OF THE INVENTION

Human locomotion, such as walking and running, is commonly described in terms of gait or a gait cycle. Gait is a cyclical or reoccurring pattern of leg and foot movement, rotations, and torques that creates locomotion. Due to the repetitive nature of gait, gait is typically analyzed in terms of percentages of a gait cycle. A gait cycle is defined for a single leg beginning with the initial contact of the foot with a surface such as the ground. The initial contact of the foot on the ground is referred to as a heel strike. The conclusion of a gait cycle occurs when the same foot makes a second heel strike. A gait cycle can be divided into two phases: stance phase and swing phase. Stance phase describes the part of the gait cycle where the foot is in contact with the ground. Stance phase begins with heel strike and ends when the toe of the same foot leaves the ground. Swing phase describes the part of the gait cycle where the foot is in the air and not in contact with the ground. Swing phase begins when the foot leaves contact with the ground and ends with the heel strike of the same foot. For walking gait speed, stance phase typically describes approximately the first 45%-60% of the gait cycle, while swing phase describes approximately the remaining 40%-55% of the gait cycle.

Individuals have unique gait patterns. Energy or metabolic expenditure during an individual's gait depends on several factors including, body mass, stride length, step rate, and other physical and environmental factors. An individual's physical and metabolic limits determine the speed and distance an individual can travel on foot. Decreasing the metabolic cost for an individual's gait allows the individual to run faster or travel for a longer distance while minimizing the energy expended by the individual.

Fatigue and injury can result from overuse or from strenuous activity, such as long distance walking and load carrying. Carrying significant loads over long distances and time periods can lead to fatigue and cause musculoskeletal injuries. Various types of jobs and activities require people to carry loads. Military personnel are considered particularly at risk for fatigue and injury from carrying loads. As the quantity and complexity of gear used in military duty has increased, the weight of loads carried by military personnel has also increased. Many soldiers carry a variety of devices, such as night goggles, global positioning systems (GPS), body armor, and other gear. Even when maximum weights for human-carried loads are recommended, the recommended maximums are often exceeded and heavier loads are carried. For example, typical loads carried by soldiers can range between 45 kilograms (kg) to 60 kg or more. Soldiers often carry the loads for long distances while marching on foot.

The relationship between distance traveled and the rate of metabolic energy expended is exponential in nature. The metabolic cost of gait depends on the speed of gait and the weight of a load carried by the individual. When carrying a heavier load, the speed of a march is decreased in order to avoid fatigue. Fatigue has been shown to have detrimental effects on individuals who carry the heavy loads. Fatigue is known to increase likelihood of acute injury by raising the potential for trips and falls. Fatigue can also affect mental focus, reduce situational awareness, and negatively impact overall physical and mental performance. Non-combat related injuries caused by carrying significant loads are also a problem. Long term and chronic overuse injuries account for a significant amount of injuries for soldiers.

Various types of structures and exoskeletons have been proposed to support or lessen the effective weight of human-carried loads. Load assistance structures and exoskeletons add external weight to the user even while supporting weight of a carried load. The weight of the exoskeleton itself can encumber a user's gait by shifting the weight uncomfortably or out of synch with the gait cycle. Current load assistance structures that perturb the user's gait increase the user's metabolic expenditure. Interference with gait creates inefficiencies in energy use by altering the fluidity of the gait motion. Disruption of the natural gait step causes an increase in metabolic cost. Altering an individual's gait dynamics also increases the likelihood of acute and chronic injury.

### SUMMARY OF THE INVENTION

A need exists for a lighter weight load support system that assists users in carrying heavy loads and that allows for substantially unencumbered gait. Accordingly, in one embodiment, the present invention is a method of supporting a load carried by a user comprising the steps of coupling a first link to the load, and coupling a second link to a first foot of the user. The second link pivotally coupled to the first link at a first joint. The method further includes the steps of disposing a first damping element between the first and second link, disposing a first sensor on a first limb of the user, measuring with the first sensor a physical characteristic of the first limb, and selecting a damping constant of the first damping element based on the physical characteristic of the first limb to support the load.

In another embodiment, the present invention is a method of controlling a load support device comprising the steps of coupling a link assembly to a load and to a first foot of a user, disposing a first damping element spanning a joint of the link assembly, disposing a first sensor on a first limb of the user, measuring with the first sensor a physical characteristic of the first limb, and selecting a damping constant of the first damping element based on the physical characteristic of the first limb to support the load.

In another embodiment, the present invention is a method of controlling a load support device comprising the steps of coupling a first link assembly to a load and to a first foot of a user, coupling a first damping element to the first link assembly, disposing a first sensor on a first limb of the user, measuring with the first sensor a physical characteristic of the first limb, and modulating the first damping element based on the physical characteristic of the first limb.

In another embodiment, the present invention is a load support device comprising a first link assembly configured to couple to a load and to a first foot of a user. A first damping element is coupled to the first link assembly between the load and the first foot. A sensor is coupled to a limb of the user and is configured to determine a gait characteristic of the user. An actuator is coupled to the first damping element. The actuator is configured to open or close the first damping element based on the gait characteristic of the user.

### BRIEF DESCRIPTION OF THE DRAWINGS

FIG. 1 illustrates a gravitational load support system worn by a user;

FIGS. 2a-2d illustrate a schematic diagram of a gravitational load support system;

FIGS. 3a-3c illustrate the effect of a load and a gravitational load support system on a user's posture and gait;

FIG. 4 illustrates a tension spring-based actuator used for a gravitational load support system;

FIGS. 5a-5b illustrate schematic diagrams of coils in a spring-based actuator used for a gravitational load support system;

FIG. 6 illustrates a graph of a spring-based actuator control patterns;

FIGS. 7a-7b illustrate a graph of the relationship of motor power consumption to percentage of a gait cycle during use of a gravitational load support system;

FIGS. 8a-8b illustrate a graph of kinematic results measured from a user wearing a gravitational load support system;

FIG. 9 illustrates a schematic diagram of alternative load support systems;

FIG. 10 illustrates a load support system worn by a user;

FIGS. 11a-11f illustrate a method of using a load support system;

FIG. 12 illustrates a double-acting piston embodiment of a damping element;

FIGS. 13a-13f illustrate a method of using a damping element in a load support system;

FIGS. 14a-14b illustrate reference functions for use in a method of controlling a load support system;

FIG. 15 illustrates a method of controlling a load support system;

FIG. 16 illustrates additional detail of a method of controlling a load support system;

FIG. 17 illustrates a method of processing sensor data for controlling a load support system;

FIG. 18 illustrates an alternative method of processing sensor data for controlling a load support system;

FIG. 19 illustrates a plot of an instantaneous rotation of the foot for use in controlling a load support system;

FIG. 20 illustrates a reference function for use in a method of controlling a load support system;

FIGS. 21a-21d illustrate schematic diagrams of alternative load support systems;

FIG. 22 illustrates a load support system including an adjustable load transmission point;

FIGS. 23a-23d illustrate schematic diagrams of adjustable load transmission points;

FIGS. 24a-24b illustrate a track guide for adjusting a load transmission point;

FIGS. 25a-25b illustrate four-bar mechanism for adjusting a load transmission point; and

FIGS. 26a-26b illustrate a six-bar mechanism for adjusting a load transmission point.

### DETAILED DESCRIPTION OF THE DRAWINGS

The present invention is described in one or more embodiments in the following description with reference to the figures, in which like numerals represent the same or similar elements. While the invention is described in terms of the best mode for achieving the invention's objectives, those skilled in the art will appreciate that the description is intended to cover alternatives, modifications, and equivalents as may be included within the spirit and scope of the invention as defined by the appended claims and their equivalents as supported by the following disclosure and drawings.

Exoskeletons for load support are disclosed herein for minimizing the weight of a human-carried load felt by a user. In particular, the load support systems minimize the impact of a carried load on a user's gait. The exoskeletons disclosed herein support a user's carried load, such as a pack, and are configured to support the carried load throughout each entire gait cycle in order to decrease the weight of the carried load felt by the user, thereby improving the user's gait efficiency and allowing the user to carry the load for greater time periods and over longer distances.

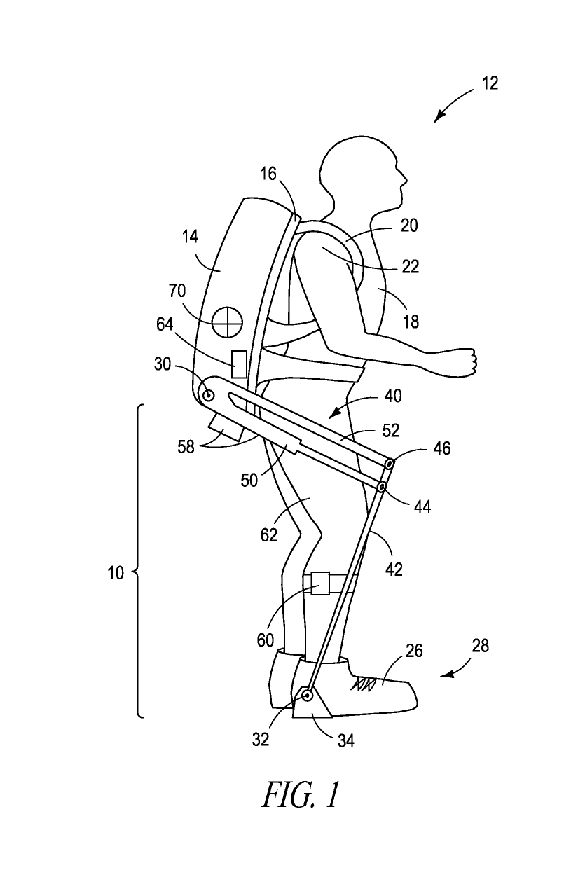

FIG. 1 shows a gravitational load support system 10 worn by user 12. Gravitational load support system 10, also referred to as load support system 10, operates as a lower body exoskeleton for supporting the external weight of a carried load by transferring the external weight through load support system 10 into the ground. When transporting or carrying external weight, such as load 14, user 12 may carry load 14 in a pack or backpack 16 worn on an upper torso 18 of user 12. Load 14 may include a piece of equipment or a tool with or without an arm or linkage coupling the tool to load support system 210. Load 14 may be coupled to user by a frame, harness, or other apparatus configured for the type of equipment of load being carried. In one embodiment, user 12 carries a load 14 using a backpack 16 worn on an upper torso 18 of user 12. Backpack 16 includes straps 20 that may be worn over the shoulders 22 of user 12, with straps 20 representing an attachment point of load 14 to user 12. However, load 14 may couple to user 12 at other points on the body of user 12, such as the waist, chest, or any part of the upper torso 18 or body of user 12. User 12 experiences forces from the weight of load 14 at the attachment points, such as shoulders 22. Load support system 10, allows weight from load 14 to bypass the user by absorbing and transmitting the weight through the structure of load support system 10 and into the user's footwear 26 and into the ground.

Load support system 10 includes a system of linkages that transmits load 14 worn on upper torso 18 to footwear 26 worn on the user's feet 28. Load support system 10 couples to load 14 and footwear 26. As user 12 walks, load support system 10 transfers the gravitational load 14 from upper torso 18 into footwear 26. Load support system 10 couples to load 14 at a load receptor point 30. In one embodiment, load support system 10 includes a load receptor point 30 coupled to backpack 16 or to a frame of backpack 16.

Load support system 10 further couples to a load transmission point 32. In one embodiment, load support system 10 includes a load transmission point 32 coupled to footwear 26 and footwear attachment 34. By coupling load support system 10 to backpack 16 and footwear 26, donning and doffing of load support system 10 is simplified for user 12. Load support system 10 is thus disposed between load receptor point 30 and load transmission point 32 to transmit the gravitational load 14 to load transmission point 32. Load support system 10 further includes a load receptor point 30 and a load transmission point 32 on each side of user 12 or load 14. Thus, a load transmission point 32 is coupled to footwear 26 on each of the user's feet 28.

Load support system 10 includes an upper link 40 and a lower link 42 positioned on each side of load 14. In one embodiment, load support system 10 includes at least four linkages: one upper link 40 and one lower link 42 on each side of user 12. Upper link 40 couples to backpack 16 at load receptor point 30. Upper link 40 couples to lower link 42 at one or more joints 44 and 46. The joint types for joints 44 and 46 may include revolute joints, prismatic joints, screw-type joints, or other joint types. Lower link 42 couples to load transmission point 32 at a distal end of lower link 42 opposite to upper link 40. Load transmission point 32 ultimately transfers load 14 through footwear 26 and footwear attachment 34 to the ground.

Upper link 40 includes one or more links or arms. Upper link 40 includes an actuator arm 50 and passive arm 52. Actuator arm 50 is disposed between load receptor point 30 and joint 44. Passive arm 52 is disposed between load receptor point 30 and joint 46. Passive arm 52 may include any suitable linkage, such as a tension cable, rigid member, or other linkage. In one embodiment, passive arm 52 comprises a stabilizing member. Load 14 is transferred from load receptor point 30 to lower link 42 through actuator arm 50 and joint 44 and through passive arm 52 and joint 46.

Actuator arm 50 includes a spring-based actuator 58 having structure-controlled stiffness. In one embodiment, spring-based actuator 58 includes a JackSpring™ Actuator, which is further described in U.S. Pat. Nos. 7,992,849 and 8,322,695, entitled Adjustable Stiffness Jack Spring Actuator, the entire disclosures of which are incorporated herein by reference. In another embodiment, spring-based actuator 58 includes any compliant actuator, spring-based actuator, or adjustable spring-based actuator. Where alternative spring-based actuators are used, the goal of the system is to behave like a compliant or spring supported structure while foot 28 is in contact with the ground during stance phase, and to allow free movement of the leg while foot 28 is in the air during swing phase.

Spring-based actuator 58 is a mechanical element based upon the concept of adding and subtracting coils from a spring. Spring-based actuator 58 is configured to accept load 14 though load receptor point 30 and subsequently dissipate the energy stored in the spring by using an actuator. Further, spring-based actuator 58 is uni-directional, such that spring-based actuator 58 assists user 12 in a first direction, while providing no support or resistance in an opposite direction. By providing uni-directional support, spring-based actuator 58 supports load 14 during stance phase, while swing phase remains unencumbered by spring-based actuator 58. One or more links of load support assembly 10 alternately couple and decouple with spring-based actuator 58 to provide uni-directional support during gait.

Lower link 42 is pivotally coupled to upper link 40. Lower link 42 may be a fixed-length rigid linking member, or may include a prismatic link or other joint. Lower link 42 optionally includes a compliant member, active member, or a combination of compliant and active members to assist user 12 with gait while wearing load support system 10. Lower link 42 together with upper link 40 comprise a link assembly. Load support system 10 includes a link assembly and a spring-based actuator 58 disposed on each side of load 14 and user 12.

Spring-based actuator 58 allows load support system 10 to be optimally tuned for varying loads 14 carried by user 12. The stiffness of load support system 10 is adjustable such that the system may be mechanically tuned. In one embodiment, the stiffness of load support system 10 is controlled or tuned using spring-based actuator 58. Load support system 10 accommodates various weights of load 14. Tuning of the effective stiffness of the system improves dynamic support for various load levels.

A sensor or sensor system 60 is worn by user 12. In one embodiment, sensor 60 is worn on each leg 62 of user 12. Sensor 60 may be disposed on an ankle, thigh, foot, or other part of user 12. Sensor 60 detects a physical characteristic or physical state of user 12. The physical state measured by sensor 60 includes a kinematic state, a loading state, or a kinematic state and a loading state of user 12.

Load support system 10 further includes a controller or control system 64. Control system 64 is coupled to spring-based actuator 58. Measurements from sensor 60 are used by a control system 64 to control spring-based actuator 58. Control system 64 may also be used to control one or more compliant elements, motors, or active compliant members. Control system 64 uses the physical state measurement from sensor 60 to determine when user 12 is in the stance phase of gait and swing phase of gait. Control system 64 positions spring-based actuator 58 according to the user's physical state or phase of gait. When the user's foot is planted on the ground during stance phase, spring-based actuator 58 is positioned to receive a force, such as from gravitational load 14. Load 14 is transmitted from load receptor point 30 to load transmission point 32 into footwear 26 and footwear attachment 34 and to the ground. When control system 64 determines that the user's foot is lifted off the ground, during swing phase of gait, control system 64 positions spring-based actuator 58 to dissipate energy stored in spring-based actuator 58. During swing phase, load 14 is no longer transmitted from load receptor point 30 to load transmission point 32. Further, upper link 40, lower link 42, and spring-based actuator 58 are configured for uni-directional support. Uni-directional support is accomplished by resisting or preventing motion in a first direction, while permitting motion in a second direction opposite the first direction. Load support system 10 supports load 14 during stance phase, but is configured to permit leg motion during swing phase that is unencumbered by load support system 10. Because user 12 moves independently of load support system 10, control system 64 senses the kinematic motion of user 12 to determine the user's intent. Control system 64 uses the physical state measurement from sensor 60 to control spring-based actuator 58. Based on the physical state measurement, control system 64 positions spring-based actuator 58 according to the user's gait. User 12 moves without experiencing drag from load support system 10.

Control system 64 is a continuous function relating the position of spring-based actuator 58 to a measured signal. The continuous nature of control system 64 eliminates decision making by the system, if-then logic, and changes in state. By measuring kinematic or loading states, control system 64 adapts to changes in gait. In one embodiment, a processor of control system 64 operates at 1000 Hertz (Hz). Control system 64 continuously calculates an output, rather than waiting on a gait event to trigger an output. Because the measured signal and output are related by a continuous function, the output is smooth. The measured signal is phase locked to the user's gait, and thus, the output of control system 64 is phase locked to the user's gait rather than time based. Because control system 64 is not time-based, control system 64 better adapts to changes in gait.

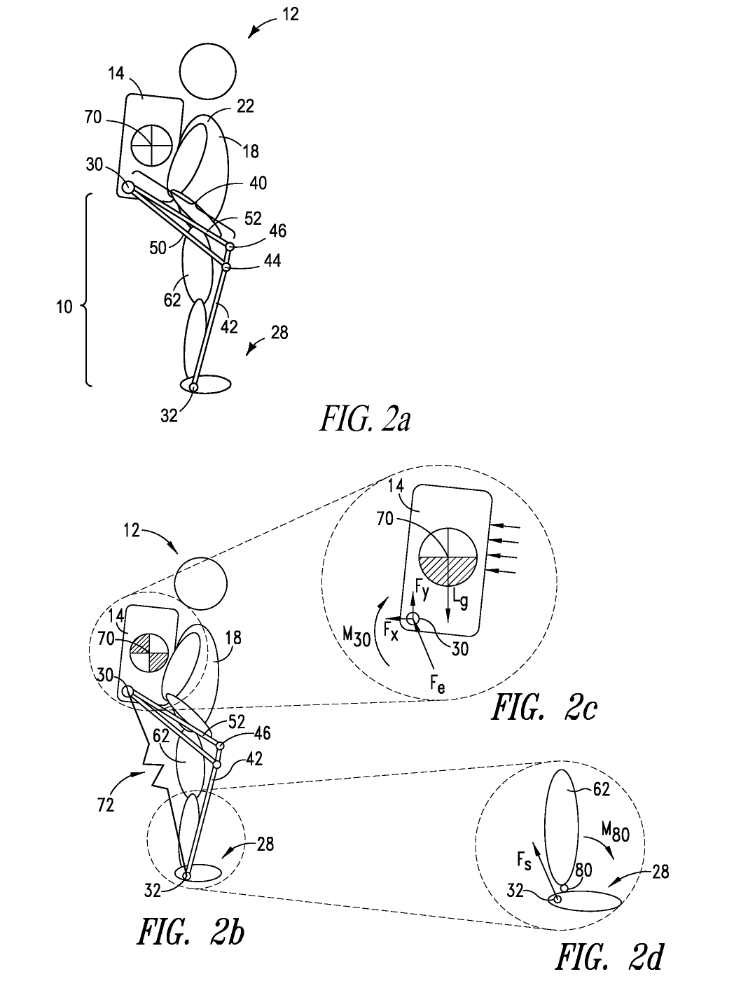

FIGS. 2a-2d show schematic representations of a gravitational load support system. FIG. 2a shows a schematic representation of load support system 10, which supports gravitational load and allows for substantially unencumbered gait. In one embodiment, load support system 10 includes at least four linkages: a lower link 42 and an upper link 40 positioned on each side of load 14. A weight of gravitational load 14 is depicted by the center of gravity 70 of load 14. Weight is transmitted from load 14, through load receptor point 30, upper link 40, lower link 42, and load transmission point 32 to the ground.

FIG. 2b shows further detail of a schematic representation of load support system 10. The attachment point for load 14 is shown at load receptor point 30, which is near a center of gravity 70 of load 14. Placement of load receptor point 30 near center of gravity 70 allows an effective spring mechanism 72 of load support system 10 to support the majority of the vertical load imposed on user 12. Placement of load receptor point 30 in a position behind upper torso 18 of user 12 and behind center of gravity 70 of load 14 causes load 14 to rotate forward and gently press into the back of the user's upper torso. Upon proper adjustment, a user feels little or no load at an upper torso 18 or load attachment point. In one embodiment, the attachment point for load 14 is shoulder area 22 where the load 14 is coupled to user 12 using straps 20 of backpack 16.

The effective structure or support of load support system 10 is represented by an effective spring 72. While a user's foot 28 is substantially stabilized on a surface, during stance phase, the system behaves like a passive spring and absorbs the weight of load 14. Effective spring 72 of load support system 10 operates in parallel with the user's leg 62. Load 14 bypasses user 12 and is directed through load support system 10 into the ground. Effective spring 72 shows how load support system 10 acts as a spring during stance phase to absorb gravitational load 14. As a user's foot 28 lifts into swing phase, effective spring mechanism 72 is driven out of the way of the actuator motor in spring-based actuator 58, allowing for fluid unencumbered walking motion by user 12.

FIG. 2c also shows schematically, with respect to FIG. 2b, the vectors and moments that result during usage of load support system 10. An effective force Fₑ of load support system 10 is shown directed into load receptor point 30. The effective force Fₑ of load support system 10 has vertical and horizontal force components F_{y} and Fₓ shown at load receptor point 30. The force vectors show that a weight or gravitational load L_{g} of load 14 is supported by the effective spring 72 having an effective force Fₑ. Where load receptor point 30 is positioned behind center of gravity 70 of gravitational load L_{g}, a moment M₃₀ is created at load receptor point 30. Load support system 10 can be positioned such that load receptor point 30 is selected to minimize moment M₃₀ in order to reduce the rotation of load 14 into the user's upper torso 18. In addition, positioning of upper link 40 and lower link 42 and attachment points 30 and 32 relative to joints of user 12 eliminates the need for motors about the hip area of user 12.

FIG. 2d shows schematically, the vectors and moments that result at ankle joint 80 during usage of load support system 10. In one embodiment, load transmission point 32 is positioned behind a user's ankle axis of rotation or ankle joint 80 to provide for balance and comfort. Where load transmission point 32 is located behind the ankle joint 80, the weight of the transmitted load adds weight at the heel of foot 28. The weight at the heel of foot 28 holds the user's heel down until user 12 is about to transfer to the opposite foot. The heel pinning effect causes improper heel rise timing during gait. The heel pinning effect is corrected by the use of torsional stiffness at load transmission point 32 or the point of rotation, such as at the ankle. A tuned and adjusted spring at or near ankle joint 80 is used to support load 14 and provide proper timing of heel rise, and reduce pinning of the heel.

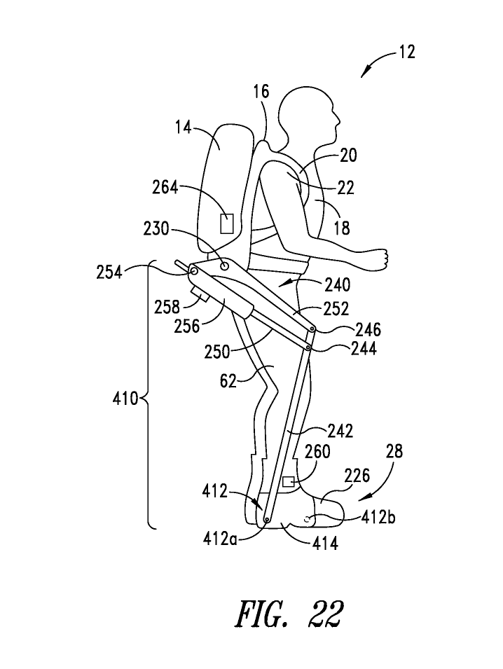

Other components may also be added to load support system 10 to improve gait timing and proper heel rise. A component added for heel rise is selected to produce a force Fₛ, which acts on the heel of foot 28 producing a moment M₈₀ at ankle joint 80. For example, a compliant element, an active element, or a combination of compliant and active elements are incorporated into load support system 10 or separately coupled to user 12 to assist with gait. In one embodiment, a compliant element, such as a spring, is coupled in proximity to load transmission point 32, foot 28, or lower link 42 to facilitate heel rise. In another embodiment, an active compliant device is coupled to foot 28 or lower link 42 to facilitate heel rise. In yet another embodiment, a linkage system is coupled between lower link 42 and foot 28 to adjust a position of load transmission point 32 or a direction of force at load transmission point 32 to reduce heel pinning, for example, as shown and described with respect to FIGS. 22-26b.

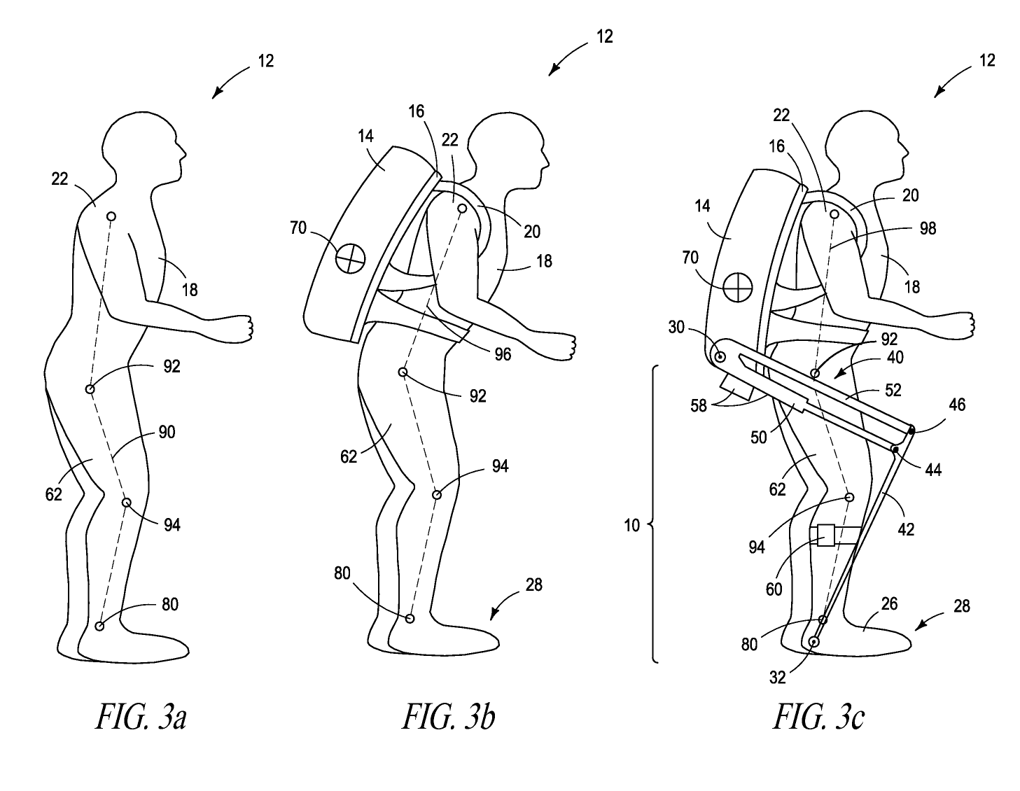

FIGS. 3a-3c show a comparison of a user carrying a load with and without a load support system. Load support system 10 was tested with a user walking under three conditions: unloaded, loaded unassisted, and loaded assisted. FIG. 3a shows user 12 in an unloaded state, walking without carrying load 14. Dashed line 90 shows the relative position of a user's limbs and joints in the unloaded state. User 12 has a normal posture with upper torso 18 situated over hip joint 92, knee joint 94, and ankle joint 80. The gait of user 12 walking at a controlled pace in the unloaded state was analyzed as a control for comparison with the loaded states shown in FIGS. 3b-3c.

FIG. 3b shows a user carrying a load without a load support system. User 12 is shown carrying a heavy load 14 in an unassisted loaded state. In one embodiment, user 12 was tested carrying a 36 kilogram (kg) load. The tested load included the weight of spring-based actuator 58, backpack 16, straps 20, and batteries. The posture and gait of user 12 changes to support the weight of load 14 and to stabilize user 12 while walking. User 12 leans forward to position the user's center of gravity for stability. Upper torso 18 is rotated forward. Load 14 is supported by shoulder area 22, upper torso 18, legs 62, hip joint 92, knee joint 94, ankle joint 80, and feet 28. Line 96 shows the orientation of the user's upper torso 18 leaning forward to adjust for load 14. The gait of user 12 walking at the controlled pace in a loaded unassisted state was analyzed. During testing, user 12 in the loaded unassisted state experienced stress that made conversation difficult for user 12, and carrying the unassisted load was the user's primary focus.

FIG. 3c shows a user carrying a load while using a load support system. In one embodiment, user 12 was tested carrying the same load as in FIG. 3b, a 36 kg load, and walking at the same controlled pace as in FIGS. 3a-3b, but with the added assistance of load support system 10. FIG. 3c shows user 12 in an assisted loaded state, wearing heavy load 14 with backpack 16 and wearing load support system 10. The posture and gait of user 12 wearing load 14 assisted by load support system 10 is more similar to natural, unloaded gait condition shown in FIG. 3a than to the unassisted loaded condition, shown in FIG. 3b. Line 98 shows that user 12 does not rotate upper torso 18 forward as far as when in the unassisted loaded state. The user does not need to shift the user's center of gravity as far forward, because a majority of load 14 bypasses the user's body though load support system 10.

Load support system 10 is coupled to the user's upper torso 18, using straps 20 of backpack 16. Other suitable attachment mechanisms may be incorporated into load support system 10 to couple the system to user 12. Load support system 10 further includes upper link 40 pivotally coupled to lower link 42. Upper link 40 is coupled to load receptor point 30 on backpack 16. Lower link 42 is coupled to footwear 26, such as shoes or boots worn by user 12, by an attachment device. As user 12 walks, load support system 10 transfers the load 14 into load transmission point 32 on footwear 26 and into the ground, thereby bypassing the user's lower body.

During testing, the gait of user 12 walking at the controlled pace was analyzed. User 12 in the assisted loaded state showed a more natural and relaxed gait than the unassisted loaded state. The testing also included a 2-dimensional motion capture analysis, which captured images of the user walking under the assistance of the system. Visual markers placed at the foot 28, ankle 80, knee 94, and hip 92 were used to determine joint kinematics for the knee and ankle during an entire step. Results showed that load support system 10 allowed the wearer normal able bodied gait motion while wearing the 36 kg load. The results of the analysis show good correspondence of the ankle and knee motions in the loaded assisted state to that of an unloaded able bodied individual. Load support system 10 does not encumber gait, because the exoskeleton system structure does not attach to the anatomical limbs of user 12 and thus cannot force user 12 into any particular gait style. Rather, load support system 10 is designed to allow able-bodied gait to occur naturally even when carrying a significant load. In the tested embodiment, load 14 included a 23 kg weight plus the 13 kg weight of load support system 10. Load support system 10, however, is also designed to support weights greater than 23 kg. Load support system 10 is not limited to a specific maximum weight. Load support system 10 is scalable to support weights equivalent to the maximum load worn by a user. Load support system 10 is not limited to providing assistance during walking, but is programmable and reprogrammable to support other modes of gait, for example, inclines, stairs, and running.

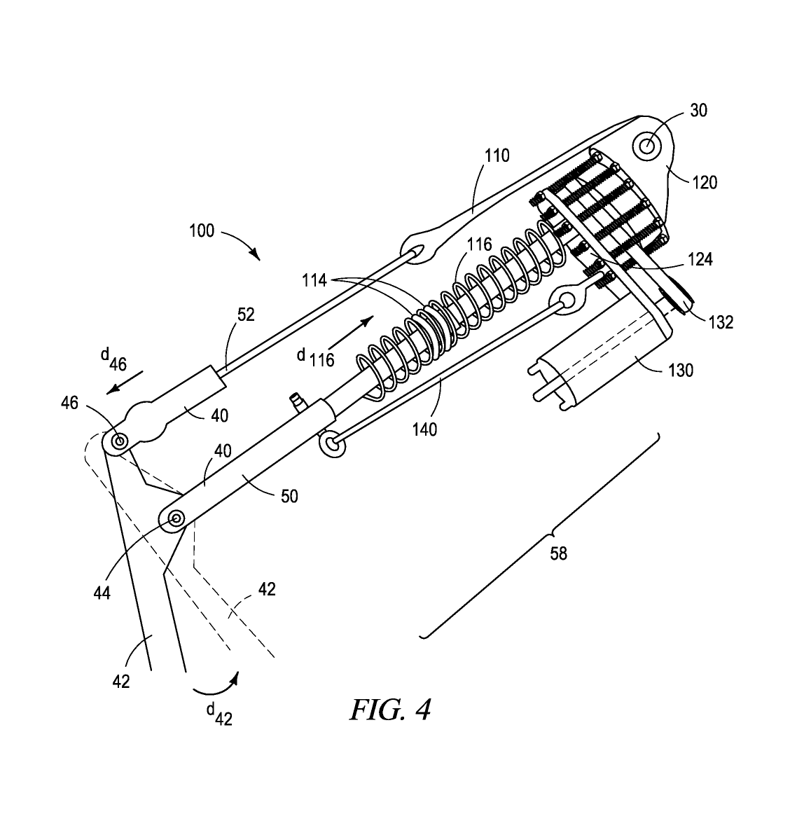

FIG. 4 shows a tension spring-based actuator assembly used for load support system 10. Spring-based actuator 58 is a mechanical element that adds or subtracts active coils from a spring. Spring-based actuator 58 allows load support system 10 to be optimally tuned for varying loads 14 carried by user 12. For the purpose of power optimization, spring stiffness tuning is a desired attribute of spring-based actuator 58. In addition, spring-based actuator 58 for load support system 10 is further designed to be uni-directional. Spring-based actuator 58 provides support between load 14 and the ground, but will allow user 12 to swing each leg faster than the capability of spring-based actuator 58, or other motors or controls. In one embodiment, load support system 10 includes a tension spring-based actuation assembly 100. In another embodiment, load support system 10 includes a compression spring-based actuation assembly.

Tension spring-based actuation assembly 100 includes actuator arm 50 and passive arm 52 substantially parallel to actuator arm 50. Actuator arm 50 is disposed between load receptor point 30 and joint 44. Passive arm 52 is disposed between load receptor point 30 and joint 46. Actuator arm 50 includes spring-based actuator 58. Spring-based actuator 58 is an assembly including a tension cable 110 a spring actuation nut 114, and a spring 116.

Tension cable 110 couples to joint 46 and extends around a pulley 120 at load receptor point 30. In one embodiment pulley 120 includes a pulley belt arrangement with a 3:1 ratio. Tension cable 110 extends through a hollow portion of actuator arm 50 and couples to spring actuation nut 114. Tension cable 110 may include additional linkages, such as a turnbuckle, or other fasteners. Spring 116 includes a compliant coil spring disposed around actuator arm 50. Spring 116 interfaces with spring actuation nut 114. Spring actuation nut 114 is disposed between coils of spring 116. In one embodiment, spring actuation nut 114 includes threads, which fit between the coils of spring 116. In one embodiment, spring actuation nut 114 includes one or more pins, or one or more pins in radial bearings, or another nut configuration. Spring actuation nut 114 further couples to tension cable 110 through an opening, such as a slit, in actuator arm 50. Spring actuation nut 114 fits through the opening in actuator arm 50 to attach to tension cable 110 at an attachment point within actuator arm 50.

When user 12 is in stance phase, foot 28 is in contact with the ground. Load support system 10 using tension spring-based actuation assembly 100 receives load 14 at load receptor point 30. As the user's leg 62 moves through stance phase, lower link 42 rotates in direction d₄₂ as force is directed from load receptor point 30 through actuator arm 50 to joint 44 and into lower link 42. Passive arm 52 is pulled at joint 46 in direction d₄₆ causing tension in tension cable 110. When tension is applied to tension cable 110, tension cable 110 pulls on spring actuation nut 114 at the attachment point inside actuator arm 50.

As tension cable 110 pulls on spring actuation nut 114, spring actuation nut 114 acts on the active coils in spring 116. The deflection of spring 116 is in direction d₁₁₆. When spring 116 deflects, the energy of load 14 is stored in spring 116. The deflection of spring 116 allows load support system 10 to support load 14 during stance phase.

Spring-based actuator 58 further includes a motor or actuator 130. Actuator 130 couples to spring 116 through a belt or gear assembly 132. In one embodiment, actuator 130 is a direct current motor operating at up to 8,000 revolutions per minute (RPM). Belt assembly 132 couples to spring 116 to drive a rotation of spring 116. Actuator 130 engages to rotate spring 116 to translate spring actuation nut 114 to reduce the number of active coils in spring-based actuator 58 and thereby dissipating the energy stored in the spring. Actuator 130 rotates spring 116 to drive slack into tension cable 110. The slack in tension cable 110 allows user to move into swing phase unencumbered by load support system 10. Spring-based actuator 58 may further include additional support structures, such as support cable 140.

Tension cable 110 is used to provide a uni-directional application of force to spring-based actuator 58. Thus, tension cable 110 provides a supporting force to the carried load in the upper link 40 when the user's foot 28 is on the ground during stance phase. Tension cable 110 also allows the user's leg 62 to effectively decouple from spring-based actuator 58 while in swing phase, thereby allowing leg 62 to move freely and unencumbered. A uni-directional actuator effect can be accomplished by tension or compression. In tension spring-based actuation assembly 100, compressive loading in spring-based actuator 58 system is ignored and not transmitted to the overall system. A reversed system, which uses compression rather than tension, operates using the same concepts as in tension spring-based actuation assembly 100. Load 14 is transferred into a spring, by either tension or compression, and an actuator drives the nut or the spring to dissipate the energy stored in the spring.

In an alternative embodiment, gravitational load support system includes a compression spring-based actuator assembly. The compression spring-based actuation assembly includes actuator arm 50 and passive arm 52 substantially parallel to actuator arm 50. Actuator arm 50 is disposed between load receptor point 30 and joint 44. Passive arm 52 disposed to load receptor point 30 and joint 46. Passive arm 52 is a rigid member, rather than a tension cable, and is pivotally coupled to lower link 42 at joint 46. Actuator arm 50 includes spring-based actuator 58. A portion of actuator arm 50 is configured to alternately couple and decouple with spring-based actuator 58. During stance phase, actuator arm 50 couples to spring-based actuator 58. During swing phase, actuator arm 50 decouples from spring-based actuator 58 by creating a gap between a portion of actuator arm 50 and spring 116 in spring-based actuator 58. The portion of actuator arm 50 extending from joint 44 temporarily decouples from spring 116 to provide substantially unencumbered motion as lower link 42 moves in a direction opposite to direction d₄₂.

In the compression configuration, spring-based actuator 58 is an assembly including a spring actuation nut 114, a spring 116. Similarly to the tension configuration, spring 116 is disposed along actuator arm 50 and interfaces with spring actuation nut 114. Spring actuation nut 114 is disposed between coils of spring 116 and couples to actuator 130.

When user 12 is in stance phase, load support system 10 using compression spring-based actuation assembly receives load 14 at load receptor point 30. As the user's leg 12 moves through stance phase, lower link 42 pivots at joint 46 and rotates in direction d₄₂. As lower link 42 moves in direction d₄₂, actuator arm 50 is compressed. Actuator arm 50 pushes on spring 116 to compress spring 116. As actuator arm 50 compresses spring 116 against spring actuation nut 114, the coils in spring 116 that are disposed between spring actuation nut 114 joint 44 compress. When spring 116 is compressed, the energy of load 14 is stored in spring 116 and load support system 10 supports load 14 during stance phase.

In the compression configuration, spring-based actuator 58 further includes an actuator 130. Actuator 130 couples to spring 110 through a belt or gear assembly 132. Gear assembly 132 couples to spring actuation nut 114 to drive a rotation of spring actuation nut 114. Actuator 130 engages to rotate spring actuation nut 114 to translate spring 116 to reduce the number of active coils in spring-based actuator 58 and thereby dissipating the energy stored in spring 116. Actuator 130 drives spring 116 away from actuator arm 50 to decouple actuator arm 50 from spring 116. The decoupling of actuator arm 50 from spring 116 creates a gap along actuator arm 50, between joint 44 and spring 116, that allows user 12 to move into swing phase unencumbered by load support system 10.

A compression spring-based actuation assembly provides a uni-directional application of force in load support system 10. Thus, spring-based actuator 58 provides a supporting force to the carried load in the upper link 40 when the user's foot 28 is on the ground during stance phase. Spring-based actuator 58 also allows the user's leg 62 to effectively decouple from spring-based actuator 58 while in swing phase, thereby allowing leg 62 to move freely and unencumbered. A uni-directional actuator effect can be accomplished by tension or compression.

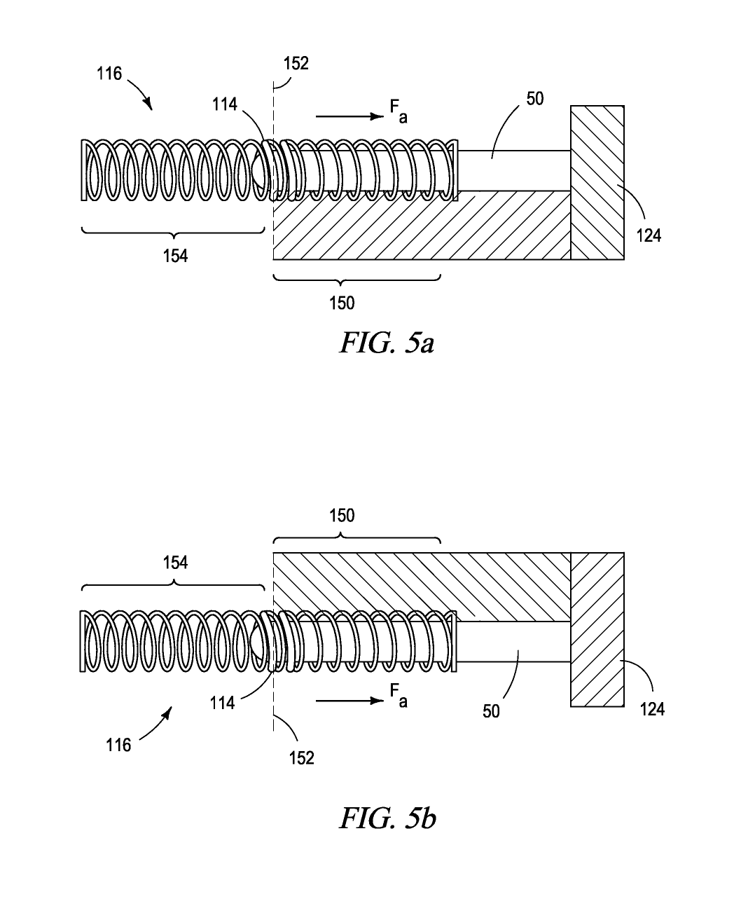

FIGS. 5a-5b show schematic diagrams of coils in a spring-based actuator used for a load support system. FIG. 5a shows a position of a spring-based actuator having a region of active coils defined by a nut. Spring-based actuator 58 includes a helical or coil spring 116 where the number of active coils 154 is adjustable by rotating spring 116, or alternatively, by rotating spring actuation nut 114. Spring-based actuator 58 is comparable to a lead screw. The lead and pitch for spring-based actuator 58 are variable based upon an imposed axial force Fₐ. Active coils 154 are defined by a position of spring actuation nut 114. A position of spring actuation nut 114 is indicated by line 152. Inactive coils 150 are shown in a position opposite spring actuation nut 114 from active coils 154. As spring 116 or spring actuation nut 114 rotates, the number of active coils 154 changes. In one embodiment, the spring 116 translates along the length of actuator arm 50 to change the number of active coils 154.

FIG. 5b shows a position of a spring-based actuator having a region of fewer active coils than the position shown in FIG. 5a. The stiffness of a coiled spring is a function of geometry, material, and number of active coils, such as active coils 154. In most springs, the stiffness Kₛ of the spring is constant or fixed. For spring-based actuator 58, however, the number of active coils 154 is adjusted and thus the stiffness Kₑ of the mechanism is adjusted. In FIG. 5b, the position of spring actuation nut 114 and spring 116 shows fewer active coils 154 available to do work, causing spring-based actuator 58 to have less stiffness than where fewer active coils 154 are available.

Spring-based actuator 58 offers a combination of compliance, energy storage, and actuation. In addition, because spring-based actuator 58 acts similarly to a lead screw system, a lightweight gearbox is built-in to the system. The adjustability of the position and stiffness of spring 116 allows spring-based actuator 58 to include properties of energy storage or energy dissipation. Energy storage is achieved during spring 116 loading. Energy dissipation is achieved by allowing spring 116 to absorb a load or axial force Fₐ and then drive the spring backwards so that spring 116 does not return that stored energy to the environment.

The lead of spring-based actuator 58 is a function of force Fₐ, and the stiffness Kₑ of the device is a function of the number of active coils 154. The functions related to the response of actuator 130 are defined on a per coil basis. For example, the deflection of actuator 130 is defined in terms of the deflection of a single coil, rather than overall unit length change.

$$τ = \frac{β \cdot {l}_{o}^{2}}{2 π} \cdot [ {( \frac{l}{{l}_{o}} )}^{2} - \frac{l}{{l}_{o}} ] \cdot \frac{l}{{l}_{o}} \cdot [ \frac{\frac{l}{{l}_{o}} + μ cot {α}_{o}}{1 - μ \cdot \frac{l}{{l}_{o}} tan {α}_{o}} ] \qquad ( 1 )$$

Where:
τ=actuator torque
β=spring stiffness of a single coil
l=spring lead
lₒ=spring un-deflected lead
α=lead angle
μ=offset variable

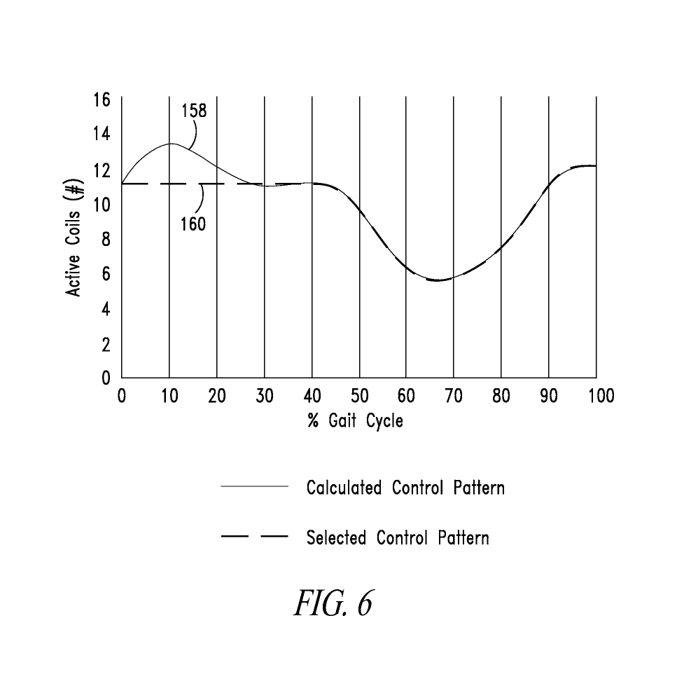

Equation (1) describes the torque necessary to be applied to spring-based actuator 58 in order to achieve a lifting load. The load or force in equation (1) is captured by the ratio l/lₒ, which is the deflection of spring 116. The variables l and lₒ represent the lead of spring 116 and the un-deflected lead of spring 116, respectively, and β represents the single coil spring stiffness. The remaining terms in equation (1) are used to develop the resulting friction influence. Equation (1) is applied to the specific geometry of the linkages in load support system 10. The relationships are combined with normal, able-bodied gait dynamics, and a resulting tuned control pattern is developed, as shown in a graph in FIG. 6.

FIG. 6 shows a graph of two spring-based actuator control patterns and shows the relationship of active coils in spring-based actuator 58 with respect to the percentage of gait cycle. Line 158 shows a tuned path of a control pattern for spring-based actuator 58. Line 158 represents the number of active coils 154 in spring-based actuator 58 engaged using a calculated control pattern. In early stance phase, known as load acceptance, spring-based actuator 58 drives nut 114 to increase the total number of active coils 154 engaged in spring 116. During stance phase for the first 50-60% of a gait cycle, load support system 10 accepts load 14 and spring-based actuator 58 is positioned with a high number of active coils 154. The number of coils in a spring is inversely proportional to stiffness. Thus, increasing the active coil count has an effect of reducing the stiffness of the spring, such that spring 116 feels softer. However, in spring-based actuator 58 there exists a coupling between stiffness and actuator 130 displacement. Although the stiffness decreases, the amount of load acceptance increases. Line 158 represents the number of active coils 154 in spring-based actuator 58 when spring-based actuator 58 is controlled using a calculated control pattern. During swing phase for the remaining 40-50% of the gait cycle, the number of active coils 154 is decreased by actuator 130.

Line 160 shows a selected control pattern developed based on the calculated control pattern in line 158. Line 160 represents the number of active coils 154 in spring-based actuator 58 with the selected control pattern. Line 160 represents a control path used for load support system 10 for walking. During stance phase, the first 50-60% of a gait cycle, load support system 10 accepts load 14 and spring-based actuator 58 holds the number of active coils 154 constant. The difference between the control pattern shown by line 158 and the control pattern shown by line 160 is that the initial active coil count of spring 116 is held as a constant for nearly half of the walking gait cycle in line 160, the majority of the stance phase. Thus, for the first half of a step, actuator 130 remains off and the passive properties of spring 116 are engaged as shown by line 160. During the second half of the walking gait cycle, actuator 130 activates to support leg movement during the swing phase of gait. During swing phase, the number of active coils 154 is decreased by actuator 130. To support uni-directional actuation, load support system 10 does not prevent user 12 from stepping out farther or faster than actuator 130 can drive. The uni-directional actuator behavior allows an unencumbered swinging motion of the leg, and also allows user 12 to accomplish a greater stride, to compensate for obstacles in the path, such as potholes, branches, or any other walking hazard. The goal of load support system 10 is to support the load while the foot is on the ground while permitting as much freedom of movement of the leg as possible while the foot is in the air.

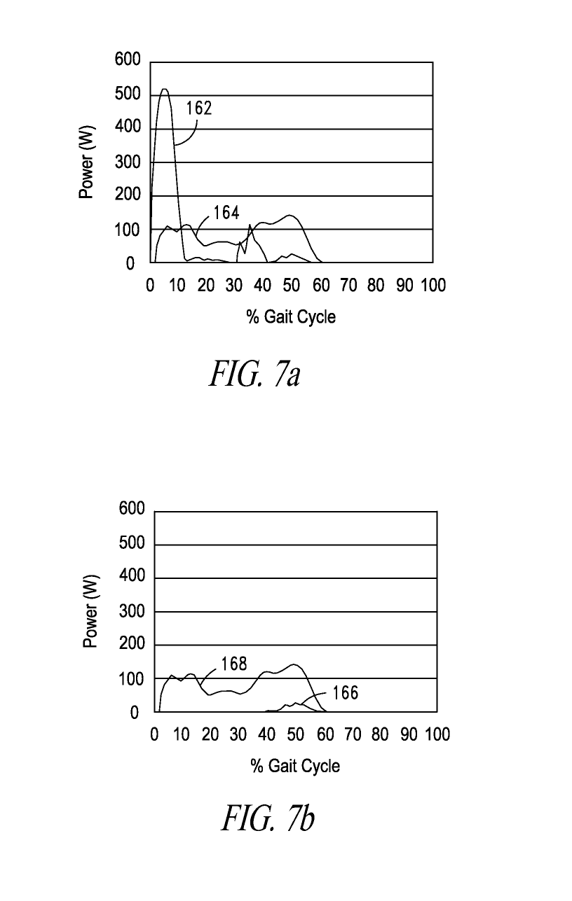

FIGS. 7a-7b show graphs of the relationship of motor power consumption to percentage of a gait cycle during use of gravitational load support system 10. FIG. 7a shows the relationship of motor power consumption in relation to percentage of gait cycle for the calculated control pattern shown by line 158 in FIG. 6. In FIG. 7a, line 162 shows the power input from a motor, and line 164 shows the resulting power output by spring-based actuator 58. When the number of active coils is increased using actuator 130 in spring-based actuator 58, the power required from the motor peaks early in the gait cycle. When actuator 130 decreases the number of active coils in spring-based actuator 58, the power required from the motor peaks again during swing phase. The motor requirements from the calculated control pattern are used to optimize the performance of spring-based actuator 58.

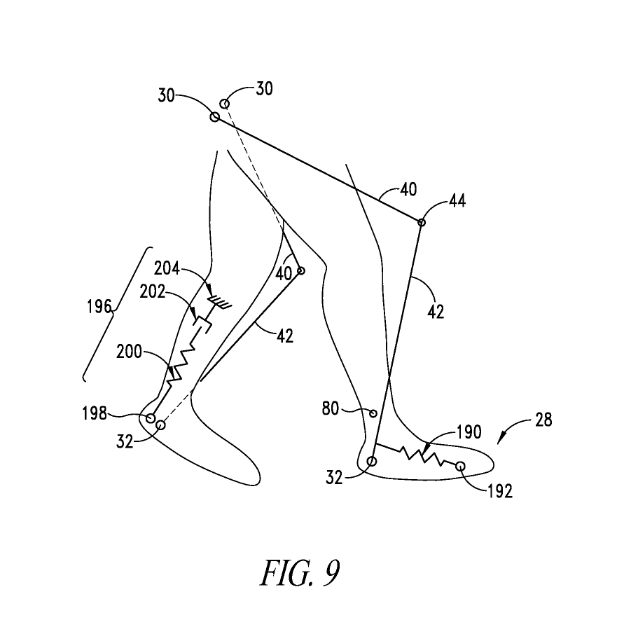

FIG. 7b shows the relationship of motor power consumption in relation to percentage of gait cycle using an alternative control pattern shown by line 160 in FIG. 6. In FIG. 9b, line 166 shows the power input from a motor, and line 168 shows the resulting power output by spring-based actuator 58. The motor power input requirements depicted in lines 162 and 168 are used to optimize the performance of spring-based actuator 58. The relationship between torque and motor speed in spring-based actuator 58 shows that high speed motion may exceed the maximum threshold of an 8,000 RPM motor. In one embodiment, actuator 130 for spring-based actuator 58 includes an RE-40 motor and has a maximum speed of 8,000 RPM. The maximum speed of an RE-40 motor increases as torque decreases. Even where motor torque is reduced and motor speed is maximized, a user may move faster than the motor is capable of rotating. Where a user exceeds motor speed, the user feels drag or resistance from the motor. However, in load support system 10, where the user moves faster than the motor, the decoupling of spring-based actuator 58 prevents user 12 from feeling resistance from actuator 130. The uni-directional spring-based actuator 58 allows load support system 10 to operate faster than the maximum speed of actuator 130, when user 12 drives the system during swing phase. Actuator 130 is designed to maximize overall torque utilization, which has an effect of maximizing its overall operational efficiency.

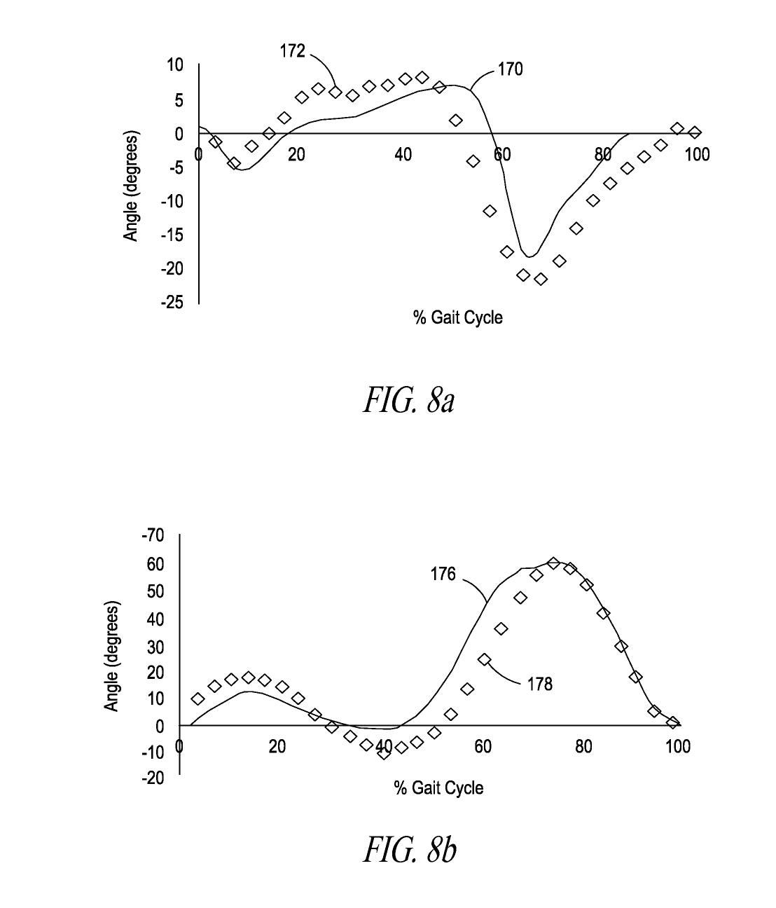

FIGS. 8a-8b show a graph of kinematic results measured from a user wearing a gravitational load support system. FIG. 8a shows a graph comparing the kinematics of a human ankle for able-bodied gait and loaded assisted gait. Line 170 shows ankle angle kinematics during one gait cycle for unloaded able-bodied gait. Line 172 shows ankle angle kinematics during one gait cycle for user 12 wearing load 14 and load support system 10. Line 172 shows that the kinematics of the ankle while using load support system 10 to support load 14 is similar to the kinematics of the ankle while user 12 is not wearing load 14, shown by line 170.

FIG. 8b shows a graph comparing the kinematics of the human knee for able-bodied gait and loaded assisted gait. Line 176 shows knee angle kinematics during one gait cycle for unloaded able-bodied gait. Line 178 shows knee angle kinematics during one gait cycle for user 12 wearing load 14 and load support system 10. Line 178 shows that the kinematics of the knee while using load support system 10 to support load 14 is similar to the kinematics of the knee while user 12 is not wearing load 14, shown by line 176. Line 178 shows that without a compliant element added during heel rise, the knee joint is slightly hyperextended. A compliant element, or spring, is added to load support system 10 to improve the timing of a user's gait and prevent joint hyperextension.

FIG. 9 shows a schematic diagram of an alternative load support system. In one embodiment of load support system 10, the weight of the transmitted load is directed into load transmission point 32 at or near the heel of foot 28. When the transmission point 32 is placed at the heel, user 12 feels the added weight at the heel of foot 28. The weight at the heel of foot 28 holds the user's heel down until user 12 is about to transfer to the opposite foot. The heel pinning effect may cause improper timing of heel rise during the push-off at the end of stance phase of the gait cycle. The heel pinning effect is corrected by the use of torsional stiffness at load transmission point 32 or the point of rotation of foot 28, such as the ankle joint 80. For example, a compliant element, an active element, or a combination of compliant and active elements are incorporated into load support system 10 or separately coupled to user 12 to assist with gait. In one embodiment, a compliant element 190, such as a spring, is coupled to lower link 42 and to foot 28 at attachment point 192. As the user's leg rolls forward during stance phase, compliant element 190 is compressed. As user 12 begins heel rise, the energy stored in compliant element 190 is released and facilitates proper heel rise timing by offsetting the weight at load transmission point 32. Compliant element 190 is tuned and adjusted according to the user and to the weight of load 14. In one embodiment, compliant element 190 includes a helical, coil, or torsional spring, a leaf spring, a cable having elastic properties, or another type of compliant device.

In another embodiment, an active compliant device 196 is coupled to load transmission point 32 and the user's leg, or other fixed point to facilitate heel rise. Active compliant device 196 includes a spring 200 and actuator 202 to add energy to the user's heel rise. Active compliant device 196 comprises a robotic ankle joint worn by user 12. In one embodiment, active compliant device 196 couples to a user's lower leg or other fixed point 204. Actuator 202 may be used to tune spring 200 and to add power to gait. Actuator 202 may be controlled by control system 64 or similar system to position actuator 202 according to the user's physical state or phase of gait. Compliant element 190 and active compliant device 196 operate to produce a moment or torque at ankle joint 80. The moment produced at ankle joint 80 assists with movement of the user's foot in the direction of plantar flexion. Compliant element 190 or active compliant device 196 operates to improve the user's gait while user 12 wears load support system 10.

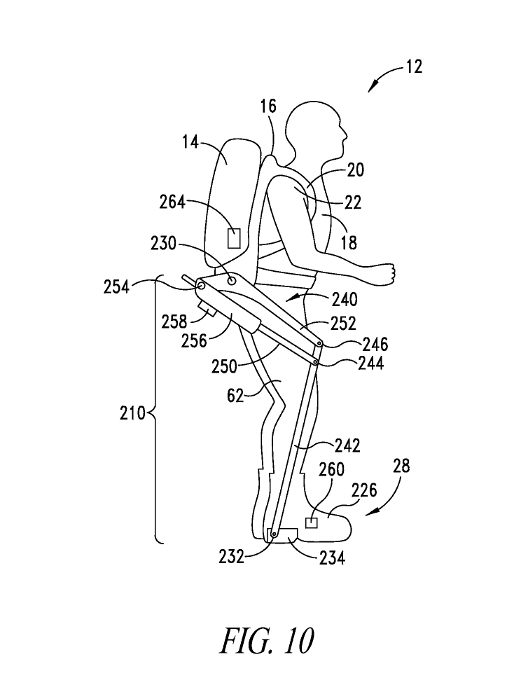

FIG. 10 shows an example of a load support system 210 worn by user 12 to support a carried load. Load support system 210 operates as a lower body exoskeleton for supporting the external weight of a carried load by transferring the external weight of the load through load support system 210 into the ground. When transporting or carrying external weight, such as a load 14, user 12 may use a pack or backpack 16 worn on an upper torso 18 of user 12. Backpack 16 includes straps 20 that may be worn over the shoulders 22 of user 12, with straps 20 representing an attachment point of load 14 to user 12. However, load 14 may couple to user 12 at other points on the body of user 12, such as the waist, chest, or any part of the upper torso 18 or body of user 12. Load 14 may include a piece of equipment or a tool with or without an arm or linkage coupling the tool to load support system 210. Load 14 may be coupled to user by a frame, harness, or other apparatus configured for the type of equipment of load being carried. User 12 experiences forces from the weight of load 14 at the attachment points, such as shoulders 22 or upper torso 18. Load support system 210 reduces the impact of load 14 on user 12 and reduces the weight that is felt by user 12. Load support system 210 allows the weight of load 14 to bypass the user by absorbing the weight through a linkage assembly and transmitting the weight into the user's footwear 226, and ultimately, into the ground. Load support system 210 operates as an exoskeleton worn by user 12 to reduce the effective weight of load 14, which is the weight of load 14 that is felt by user 12.

Load support system 210 includes a structure having one or more linkages that transmit the weight of load 14 worn on upper torso 18 into footwear 226 worn on the user's feet 28 and into the ground. Load support system 210 couples to load 14 at a load receptor point 230 and to footwear 226 at a load transmission point 232. The weight of load 14 is received by load support system 210 at load receptor point 230. In one embodiment, load receptor point 230 is located on or coupled to backpack 16 or a frame of backpack 16. The weight of load 14 is transmitted from load receptor point 230 through load support system 210 into load transmission point 232. In one embodiment, load transmission point 232 is coupled to footwear 226 by a footwear attachment 234. Thus, load support system 210 is disposed between load receptor point 230 and load transmission point 232 to transmit the weight of load 14 to load transmission point 232 and through footwear 226 into the ground, bypassing the legs 62 of user 12.

Load support system 210 further includes a load receptor point 230, a load transmission point 232, and a linkage assembly, disposed on each side of user 12 and load 14. With a load transmission point 232 coupled to footwear 226 on each of the user's feet 28, load support system 210 provides continuous support while the user is standing, walking, running, or during other gait activities, including traversing a sloped surface, maneuvering up and down stairs, or traversing an uneven surface or terrain. As user 12 moves through a gait cycle, load support system 210 alternates supporting the weight of load 14 at each foot 28 by transferring the weight into the footwear 226 of the foot 28 in stance phase. As each foot 28 alternates between stance and swing phase, load support system 210 operates by engaging or locking load support system 210 on the side of user 12 that is in stance phase in order to support load 14. By transmitting the weight of load 14 to alternate feet during gait, load support system 210 provides continuous support as user 12 moves through each gait cycle.

Load support system 210 is further configured for unencumbered gait by permitting natural movement of the user's legs 62 using uni-directional support that does not force user 12 into a particular motion. In one embodiment, load support system 210 does not attach directly to the legs 62 of user 12. The attachment points of load support system 210 are shown by load receptor point 230 and load transmission point 232 on backpack 16 and footwear attachment 234 respectively. An advantage of load support system 210 being coupled to footwear attachment 234 and backpack 16, rather than directly to the legs or body of user 12, is that user 12 can simply and easily remove footwear attachment 234 and backpack 16 in order to remove load 14 and load support system 210. By coupling load support system 210 to backpack 16 and footwear attachment 234 or footwear 226, donning and doffing of load support system 210 is simplified for user 12.

Load support system 210 includes a linkage assembly comprising an upper link 240 and a lower link 242 positioned on each side of load 14. In one embodiment, load support system 210 includes at least four linkages: one upper link 240 and one lower link 242 positioned on each side of user 12. Upper link 240 couples to backpack 16 at load receptor point 230. Load receptor point 230 may include a fixed joint, revolute joint, prismatic joint, screw-type joint, spherical joint, or other joint type or a combination of joints. Upper link 240 couples to lower link 242 at one or more joints 244 and 246, which operate as an effective knee joint of load support system 210. Joints 244 and 246 may include revolute joints, prismatic joints, screw-type joints, spherical joints, or other joint types. Joints 244 and 246 may further include one or more higher pair joint types, which are represented by a combination of revolute joints, prismatic joints, screw-type joints, spherical joints, or other joint types. Load support system 210 operates to control the angle of joint 246 by resisting or permitting rotation of upper link 240 with respect to lower link 242. By resisting rotation of upper link 240 with respect to lower link 242, load support system 210 operates as a damped, rigid, or substantially rigid structure that supports load 14.

Lower link 242 is pivotally or rotationally coupled to upper link 240. Lower link 242 may be a fixed-length rigid linking member, or may include a prismatic link or other joint. Lower link 242 optionally includes a spring or compliant element, active element, damping element or a combination of compliant, damping, or active elements. Lower link 242 together with upper link 240 comprise one embodiment of a linkage assembly for load support system 210. Lower link 242 couples to footwear attachment 234 at load transmission point 232 at or near a distal end of lower link 242 opposite to upper link 240. Load transmission point 232 may include a fixed joint, revolute joint, prismatic joint, screw-type joint, spherical joint, or other joint type or a combination of joints.

Upper link 240 further includes one or more active or passive links or arms. In one embodiment, upper link 240 includes a modulated or locking arm 250 and a passive or support arm 252. Locking arm 250 includes a controllable damper, actuator, clutch, spring based actuator, or other adjustable element. Locking arm 250 is coupled to support arm 252 and lower link 242 at any point on each of support arm 252 and lower link 242. In one embodiment, locking arm 250 couples to support arm 252 at a joint 254 and spans load receptor point 230 and joint 246. In another embodiment, locking arm 250 couples to support arm 252 between load receptor point 230 and joint 246. Locking arm 250 is disposed such that locking arm 250 spans joint 246, an effective knee joint of load support system 210, to control an angle or degree of bending at joint 246. In another embodiment, a rotary damper is coupled to joint 246 to directly control the angle or damping of joint 246.

Locking arm 250 extends between joint 244 and joint 254, load receptor point 230, or another joint along support arm 252. Support arm 252 extends between load receptor point 230 and joint 246. In one embodiment, support arm 252 extends from load receptor point 230 to locking arm 250 and from load receptor point 230 to lower link 242. Support arm 252 may include any suitable linkage, such as a rigid member, a tension cable, or other fixed or adjustable linkage. In one embodiment, support arm 252 comprises a rigid stabilizing member coupled to locking arm 250 at a joint 254. Joint 254 may include revolute joints, prismatic joints, screw-type joints, spherical joints, or other joint types. Joint 254 may further include one or more higher pair joint types, which are represented by a combination of revolute joints, prismatic joints, screw-type joints, spherical joints, or other joint types. Load 14 is transferred from load receptor point 230 through locking arm 250 and support arm 252 and through joints 254, 246, and 244 to lower link 242. Load 14 is transferred through lower link 242 to load transmission point 232, footwear attachment 234, and footwear 226 into the ground.

Locking arm 250 operates as a prismatic link, which lengthens or shortens in order to allow the angle between support arm 252 and lower link 242 to increase or decrease, respectively. Locking arm 250 includes a controllable damper or piston 256 configured to control the length of locking arm 250. A damper 256 is disposed each locking arm 250 of load support system 210 on each side of load 14 and user 12. Each damper 256 is controlled by an actuator 258 that modulates the damping provided by damper 256. In one embodiment, damper 256 includes a hydraulic piston, such as a double-acting piston, a single-acting piston, a one-way controllable valve, a rotary valve, or other hydraulic actuator. Actuator 258 controls one or more valves in the hydraulic piston of damper 256. In a double-acting piston embodiment, damper 256 includes a controllable two-way valve as well as a passive one-way valve. In one-way piston embodiment, damper 256 includes a controllable one-way valve. One goal of load support system 210 is to behave as a modulated damped supported structure while foot 28 is in contact with the ground during stance phase, and to allow free movement of the leg while foot 28 is in the air during swing phase. In another embodiment, locking arm 250 includes additional passive or active elements for additional control of locking arm 250 or damper 256. The additional elements may include compliant elements, active elements, passive joints, active compliant elements, additional dampers, or other linkages. For example, locking arm 250 may include a compliant element, such as a spring, in series with damper 256 along locking arm 250. The spring may include a helical, coil, or torsional spring, a leaf spring, a cable having elastic properties, or another type of compliant device. Upper link 240 and lower link 242 may include additional passive or active elements. For example, a compliant element may be disposed along lower link 242 or support arm 252 to operate in series with damper 256.

The damping provided by load support system 210 is adjustable to accommodate different weights of load 14. Further, the damping and support provided by load support system 210 is modulated during gait to provide continuous support of a load 14 while ensuring unencumbered motion of a user's legs 62 throughout gait. In one embodiment, the damping of load support system 210 is controlled using actuator 258 which modulates the damping constant or damping ratio of damper 256. The damping constant of damper 256 corresponds to the effective damping supplied by load support system 210. Modulating of the effective damping of load support system 210 results in load support while permitting natural movement and gait of user 12 during various gait activities. Modulating of the effective damping of load support system 210 further improves the dynamic support for various load weights. Therefore, load support system 210 accommodates various weights of load 14.

Load support system 210 is controlled using an input from one or more sensors 260. A sensor or sensor system 260, which may include a plurality of sensors, is worn by user 12 or is disposed on load support system 210. In one embodiment, one or more sensors 260 are worn on each foot 28 of user 12. Sensor 260 may be disposed on a limb or joint of user 12, such as an ankle, lower leg, thigh, foot, or other part of user 12. In another embodiment, a plurality of sensors 260 are worn on each foot 28 or each leg 62 of user 12. In yet another embodiment, sensors 260 are mounted to load support system 210. Sensor 260 detects a physical characteristic or physical state of a mobile body, such as a limb of user 12 or a link of load support system 210. Sensor 260 includes an accelerometer, vibrometer, rate gyro, potentiometer, inclinometer, pressure transducer, force transducer, load cell, or other sensor or combination of sensors. The physical state or characteristic measured by sensor 260 includes a kinematic state, a loading state, or a kinematic state and a loading state of a mobile body. A kinematic state includes an angular position, linear position, linear velocity, angular velocity, linear acceleration, or angular acceleration associated with a mobile body with reference to a fixed global frame or a frame fixed to any other mobile body. A loading state includes a moment or force experienced by the mobile body.

Load support system 210 further includes a controller or control system 264. In one embodiment, control system 264 includes a microprocessor with a motor controller. Control system 264 is coupled wirelessly or by wired connection to one or more sensors 260 and to actuator 258 of damper 256. In one embodiment, control system 264 is incorporated into the structure of load support system 210. In another embodiment, control system 264 is carried in backpack 16 or is coupled to user 12. Measurements from sensors 260 are processed using control system 264 to provide an output for controlling actuator 258 and damper 256.

Measurements from sensor 260 are used by a control system 264 to control actuator 258 to modulate the damping of damper 256. Control system 264 may also control, modulate, or engage one or more compliant elements, motors, dampers, or active compliant members of load support system 210. Control system 264 uses one or more measurements from sensor 260 to determine where user 12 is in a gait cycle, such as the percent of a gait cycle. Control system 264 positions actuator 258 to modulate damper 256 according to the user's physical state, position, phase of gait, percent of gait cycle, or other information. For example, when the user's foot is planted on the ground during stance phase, control system 264 positions actuator 258 to lock or close damper 256. By closing damper 256, load support system 210 operates as a rigid structure that supports load 14. Load 14 is transmitted from load receptor point 230 to load transmission point 232 into footwear 226 and footwear attachment 234 and to the ground. Control system 264 determines that the user's foot is lifted off the ground, during swing phase of gait, and control system 264 positions actuator 258 to unlock or open damper 256. During swing phase, load 14 is no longer transmitted from load receptor point 230 to load transmission point 232.

Load support system 210 including upper link 240, lower link 242, and damper 256 is configured for uni-directional support. Uni-directional support is accomplished by resisting or preventing motion in a first direction, while permitting motion in a second direction opposite the first direction. Uni-directional resistance can be accomplished with a one-way controllable valve, a double-acting piston, spring-based actuator 58, or other uni-directional assembly. Load support system 210 supports load 14 during stance phase, but is configured to permit leg motion that is unencumbered by load support system 210 during swing phase. Because user 12 moves independently of load support system 210, control system 264 is configured to determine information about the motion of user 12 in order to select a setting of load support system 210. Control system 264 uses the physical state measurement from sensor 260 to control actuator 258. Based on the physical state measurement, control system 264 positions actuator 258 according to information derived from or calculated based on the physical state measurement.

Control system 264 includes a continuous function relating the position of actuator 258 to a measured signal. The continuous nature of control system 264 eliminates decision making by the system, if-then logic, and changes in state. By measuring kinematic or loading states, rather than simply choosing between stance and swing phase, control system 264 adapts to changes in gait. In one embodiment, a processor of control system 264 operates at 1000 Hz. Control system 264 continuously calculates an output, rather than waiting on a gait event to trigger an output. Because the measured signal and output are related by a continuous function, the output is smooth. The measured signal is phase locked to the user's gait, and thus, the output of control system 264 is phase locked to the user's gait rather than time based. Because control system 264 is not time-based, control system 264 better adapts to changes in gait.

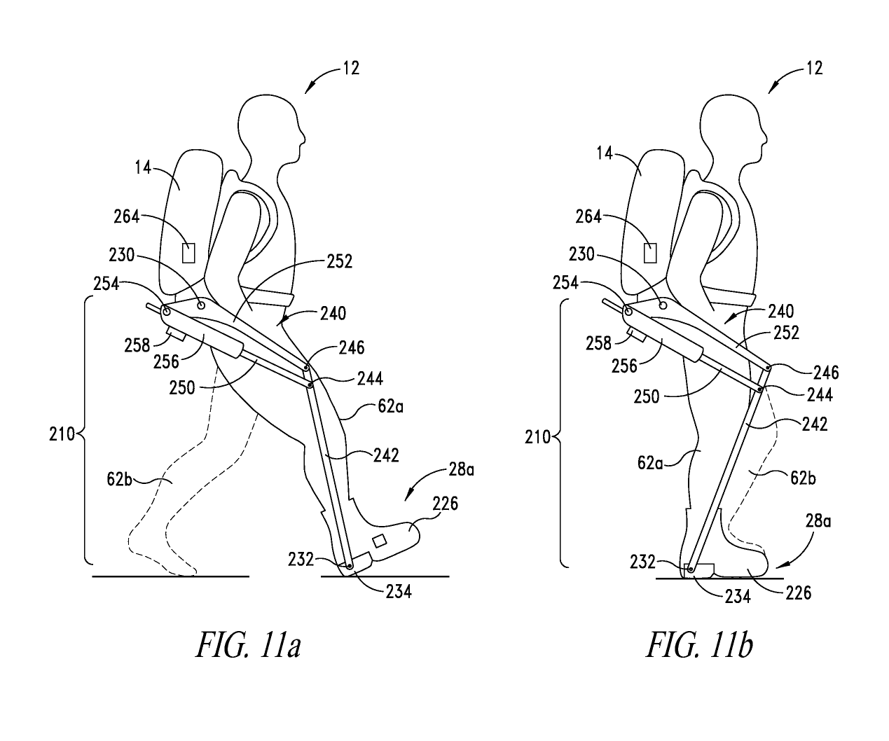

FIGS. 11a-11f show a method of using a wearable load support system 210 throughout a gait cycle. The position of load support system 10 is described for the user's right side and the right side portion of load support system 210. A left side portion of load support system 210 is not shown for the gait of the left leg, but operates similarly to the right side portion described with respect to FIGS. 11a-11f. Upper link 240 comprising support arm 252 and locking arm 250 are rotationally coupled to lower link 242 at joints 244 and 246. Joint 246 operates as an effective knee joint of load support system 210. The bending of joint 246 of load support system 210 is controlled or modulated by damper 256. In one embodiment, damper 256 is disposed along locking arm 250, which spans joint 246. Damper 256 and locking arm 250 operate as a prismatic link. Damper 256 controls the length of locking arm 250, thereby controlling the angle of joint 246. As locking arm 250 shortens, the angle of joint 246 decreases. As locking arm 250 lengthens, the angle of joint 246 increases. In one embodiment, damper 256 is configured to control the shortening of locking arm 250 when damper 256 is in a closed position, and damper 256 is further configured to permit lengthening of locking arm 250 whether damper 256 is in an open or a closed position. In another embodiment, a damper, such as damper 256, and a linkage, such as locking arm 250, are configured when locked to provide uni-directional support by resisting motion in a first direction while permitting uni-directional motion in a second direction, which is opposite to the direction of the uni-directional support. The damper and linkage are further configured when unlocked to permit bi-directional motion.

FIG. 11a shows the beginning of a gait cycle for a right leg 62a of user 12. User 12 enters stance phase on the user's right side by making a heel strike with right foot 28a contacting the ground. Right leg 62a is extended forward and lower link 242 is in a position that is rotated forward with respect to upper link 240 in the sagittal plane. Damper 256 is in a closed or locked position at heel strike. With damper 256 in a closed or locked position, the stiffness of the damper 256 is approximately infinite, meaning that damper 256 operates as a rigid link with respect to a direction opposing the force from load 14. As right foot 28a contacts the ground, damper 256 provides sufficient damping to prevent locking arm 250 from decreasing in length. Because locking arm 250 spans joint 246, when locking arm 250 is locked or fully damped, joint 246 is also locked such that the angle of joint 246 does not decrease. Locking arm 250 in a locked position allows load support system 210 to receive the weight of load 14 and transfer the weight into the ground. The weight of load 14 acts on load support system 210 at load receptor point 230. When damper 256 is closed or locked, the weight of load 14 is transmitted from load receptor point 230 through upper link 240 and lower link 242 into load transmission point 232. Load transmission point 232 is coupled to footwear which transfers the forces at load transmission point 232 into the ground, when footwear 226 is in contact with the ground.

By locking or closing damper 256 during heel strike of right foot 28a, load 14 is supported through the right side of load support system 210. At a walking gait pace, both right foot 28a and left foot 28b of user 12 are in contact with the ground during part of the gait cycle, known as the dual or double leg support. Right foot 28a makes a heel strike while left foot 28b is in push-off. During double leg support, load support system 210 may operate by supporting load 14 with both the right and left sides of the linkage assembly. After the right heel makes contact with the ground, right foot 28a begins to plantar flex until the foot is flat on the ground. The hip begins to extend from a flexed position to propel user 12 forward over the right foot 28a.

FIG. 11b shows a mid-stance position of the right leg 62a during the gait of user 12. As user 12 moves through stance phase, the knee and hip extend and right leg 62a rolls over right foot 28a resulting in the foot being dorsiflexed. Meanwhile, the user's left leg 62b is in swing phase. The right side linkages of load support system 210 continue to support load 14 during right-side stance by receiving the weight of load 14 at load receptor point 230, transferring the force from load receptor point 230 through upper link 240 and lower link 242 to load transmission point 232 on right foot 28a and into the ground. In one embodiment, damper 256 is locked throughout stance phase, and upper link 240 remains at a fixed angle with respect to lower link 242. In another embodiment, damper 256 is modulated by actuator 258 to permit some shortening of locking arm 250 during stance. Where damper 256 is slightly opened or unlocked during stance, the position of load receptor point 230 and load 14 relative to user 12 can be changed. For example, as the weight of load 14 is transferred into damper 256 at joint 254, damper 256 provides some damping and allows the effective length of locking arm 250 to be reduced. Upper link 240 rotates downward slightly with respect to lower link 242, decreasing the angle of joint 246, for example, by less than 5 degrees. The slight additional bend in joint 246 results in load 14 being lowered slightly during stance. The lowering of load 14 during mid-stance places load 14 in a more natural position and results in less disturbance of the user's gait. In either embodiment, the force of load 14 is mechanically transferred from load receptor point 230 through the damped linkage assembly and into load transmission point 232, which is coupled to the ground through footwear 226 in contact with the ground. After mid-stance, the knee stops extending and begins flexing and the foot continues to dorsiflex until heel lift begins.

FIG. 11c shows a late stance position during the gait of user 12. During late stance of the right leg 62a, right foot 28a plantar flexes and the heel of right foot 28a lifts off the ground. The right side of load support system 210 continues to support load 14 during heel rise. With respect to the right side of load support system 210, damper 256 is closed and upper link 240 remains at a fixed angle with respect to lower link 242 thereby supporting load 14. Load support system 210 accepts the weight of load 14 at load receptor point 230. The downward force of load 14 at load receptor point 230 is directed into damper 256 at joint 254. With damper 256 in a closed position, load support system 210 acts as a rigid structure that supports load 14 and prevents from the upper link 240 from rotating downward under the force of load 14. With upper link 240 held in a rigid position with respect to lower link 242, the gravitational force of load 14 is transmitted through load support system 210 into the ground.

In the completely closed position, damper 256 is configured to allow uni-directional motion by providing infinite (rigid) damping in a first direction and zero or negligible damping or resistance in an opposing direction. Damper 256 holds locking arm 250 at a fixed length under the weight of load 14 to prevent bending of load support system 210 at joints 244 and 246. Damper 256 prevents locking arm 250 from shortening, but permits locking arm 250 to lengthen even while damper is closed. When user 12 decides to extend the right leg 62, the angle between upper link 240 and lower link 242 is permitted to increase. User 12 is able to extend the knee or flex the hip without resistance from damper 256.

Meanwhile, the left leg 62b enters stance phase when the left foot 28b makes a heel strike and contacts the ground. Once left foot 28b contacts the ground, user 12 is once again in double leg stance. During double leg support, load support system 210 may operate by supporting load 14 with both the right and left sides of the linkage assembly. At the end of stance phase, right foot 28a is plantar flexed and the knee releases. The ankle reaches maximum extension and the knee flexes at toe-off.

FIG. 11d shows a toe-off position as user 12 enters the swing phase of gait for user 12 wearing load support system 210. The user's weight and the weight of load 14 is no longer transferred into right foot 28a. Damper 256 is opened to release locking arm 250, and permit load support system 210 to bend at joint 246. By opening damper 256, load support system 210 operates as a moveable structure that permits the user's leg 62 to flex or extend at the hip and to bend or straighten at the knee. With damper 256 open, the user's knee is free to bend or extend, unencumbered by load support system 210. After toe-off, the knee flexes and the ankle flexes into a slightly dorsiflexed position.

FIG. 11e shows a mid-swing position during the gait of user 12 wearing load support system 210. Damper 256 is open and provides zero or negligible damping or resistance in either direction. Opening damper 256 unlocks locking arm 250. Locking arm 250 is unlocked permitting bi-directional motion, including bending or extension at joint 246. User 12 is free to flex or extend the hip, knee, and ankle. Extending right leg 62a and rotating lower link 242 forward with respect to joint 246 increases the angle between lower link 242 and support arm 252 of upper link 240.

FIG. 11f shows the end of a gait cycle just prior to heel strike of right foot 28a. Damper 256 is close or locked prior to the heel strike of right foot 28a. Damper 256 is configured to allow uni-directional motion when in a closed position. When damper 256 and locking arm 250 permit uni-directional motion, right leg 62a may continue to swing forward and extend even while damper 256 is closed. Right leg 62a is prevented from bending when damper 256 is closed. Therefore, load support system 210 is ready in a locked position at heel strike to support load 14 when right foot 28a contacts the ground. The gait cycle for right foot 28a ends in heel strike as user 12 enters stance phase of the next gait cycle.

Without load support system 210, ground reaction forces act on the user's hip, knee, and ankle during stance phase, and user 12 adds opposing torques to resist the forces. A carried load increases the ground reaction forces on user 12, and user 12 expends more energy to counteract the forces. With load support system 210, the ground reaction forces at the hip, knee, and ankle are reduced, allowing user 12 to move with a more normal gait and to expend less energy to move at a normal gait. A normal gait is meant as the gait user 12 would have when not carrying a load or wearing a load support system.

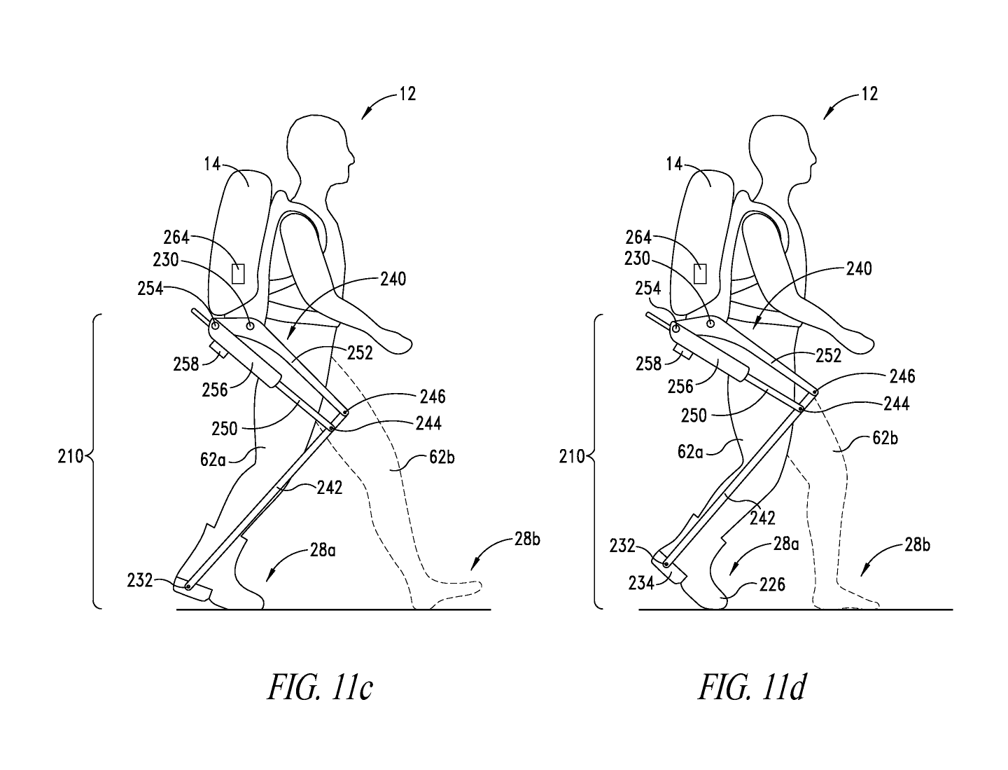

FIG. 12 shows a schematic of a hydraulic valve system for damper 256. Damper 256 is modulated by control system 264 in order to permit uni-directional motion or bi-directional motion depending on the output of control system 264. In one embodiment, damper 256 includes a double-acting hydraulic piston with a one-way check valve 270 and a controllable two-way valve 272. In an alternative embodiment, damper 256 is configured as a one-way controllable valve configured to allow uni-directional and bi-directional motion depending on the output of control system 264. In the double-acting piston embodiment, one-way check valve 270 of damper 256 may include a ball check valve, swing check valve, lift check valve, non-return valve, or other one-way flow control type valve or combination of valves. One-way check valve 270 may be passive or controllable with an actuator, such as actuator 258. Controllable two-way valve 272 may include a needle valve, butterfly valve, plug valve, gate valve, rotary valve, or other two-way flow control type valve or combination of valves. Controllable two-way valve 272 is controlled or modulated by actuator 258.

Damper 256 comprises a cylinder or chamber 274 containing a fluid 276, which may include a liquid or gas, for example, oil, air, or other fluid. A piston rod 278 comprises a ring or plunger 279 and couples to joint 244. Plunger 279 of piston rod 278 forces fluid 276 through the chamber 274 when force is applied either to piston rod 278 or to chamber shell 274 or to both. One-way check valve 270 and controllable valve 272 are configured in a parallel arrangement. One-way check valve 270 and controllable valve 272 are depicted schematically in FIG. 12, however valves 270 and 272 may be physically incorporated into damper 256 in any location while accomplishing the parallel arrangement of valves 270 and 272. For example, valves 270 and 272 may be disposed within chamber 274, such as on or within plunger 279 of piston rod 278. One-way check valve 270 operates to permit fluid 276 to flow in only a single direction through the check valve 270. In one embodiment, one-way check valve 270 is a passive valve and is always open with respect to one direction of fluid flow, thereby always permitting one-way fluid flow. Controllable valve 272 is controlled by actuator 258 to open and close the valve and to modulate the valve position, including any position between open and closed. Modulating controllable valve 272 using actuator 258 controls the rate that fluid 276 flows through controllable valve 272. When controllable valve 272 is set to a closed position, damper 256 provides approximately infinite damping, similar to a rigid structure, in a single direction. When controllable valve 272 is set to a position between open and closed, damper 256 provides damping in proportion to the degree controllable valve 272 is opened. For example, when set to a 10% open position, damper 256 provides greater damping than when in a 50% open position. When controllable valve 272 is fully open, damper 256 provides negligible or zero resistance or damping in both directions. One-way check valve 270 ensures piston rod 278 is always free to move in a direction that permits lengthening of locking arm 250 when controllable valve 272 is open or closed.

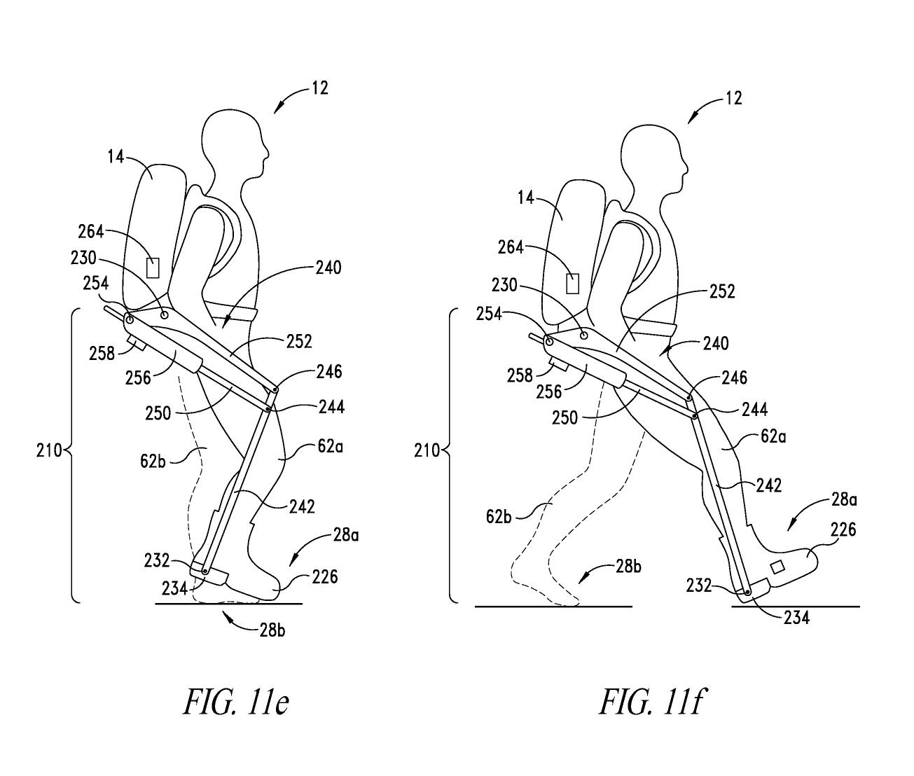

FIGS. 13a-13f show a method of using a damping element in a load support system throughout a gait cycle. FIG. 13a corresponds to an early stance position, similar to a position shown in FIG. 11a. FIG. 13a shows a double-acting hydraulic piston embodiment of damper 256 for controlling locking arm 250. At heel strike, controllable valve 272 is closed. Locking arm 250 is in a locked position and upper link 240 is prevented from rotating downward about joint 246 with respect to lower link 242. The weight of load 14, indicated by gravitational load L_{g}, is directed into load receptor point 230. Load support system 210 directs the gravitational load L_{g} into joint 254 on upper arm 240, indicated as force F₁. The force F₁ of load 14 acts on chamber 274. With locking arm 250 in a locked position, length of locking arm 250 and the angle of joints 244 and 246 are fixed in a first direction. Upper link 240 does not rotate or move with respect to lower link 242. Piston rod 278 exerts a force on fluid 276 within chamber 274, however, fluid 276 does not substantially move through chamber 274 or through valves 270 or 272. One-way valve 270 prevents fluid from moving through the valve in the direction against the valve. Controllable valve 272 in the closed position also prevents fluid from moving through controllable valve 272 in either direction. Therefore, piston rod 278 does not move downward with respect to chamber 274, and locking arm 250 does not shorten in length despite force F₁ directed into locking arm 250 at joint 254.

FIG. 13b corresponds to a mid-stance position, similar to a position shown in FIG. 11b. In FIG. 13b, at mid-stance, controllable valve 272 is in a slightly opened position. Locking arm 250 provides damping and permits upper arm 240 to rotate about joint 246. The angle of joint 246 is reduced by the lowering of upper link 240 with respect to lower link 242. Controllable valve 272 permits some bending at joints 244 and 246 to allow load 14 to lower, shown by direction d₁. Piston rod 278 moves toward joint 254 with respect to chamber 274, thereby shortening locking arm 250. Fluid 276 flows through chamber 274 in the direction of the arrows within chamber 274. Fluid 276 flows through controllable valve 272, but does not flow through one-way check valve 270.

FIG. 13c corresponds to a push-off position, similar to a position shown in FIG. 11c. In FIG. 13c, at push-off, controllable valve 272 is closed. Locking arm 250 is in a locked position and upper link 240 is prevented from rotating downward with respect to lower link 242. Piston rod 278 exerts a force on fluid 276 within chamber 274, however, fluid 276 does not substantially move through chamber 274 or through valves 270 or 272. One-way valve 270 prevents fluid from moving through the valve in the direction against the valve. Controllable valve 272 in the closed position also prevents fluid from moving through controllable valve 272 in either direction. Therefore, piston rod 278 does not move downward with respect to chamber 274, and locking arm 250 does not shorten in length despite force F₁ directed into locking arm 250 at joint 254.

FIG. 13d corresponds to a toe-off position, similar to a position shown in FIG. 11d. In FIG. 13d, controllable valve 272 is opened at toe-off to allow unencumbered swing of the leg. During swing phase, controllable valve 272 permits free lengthening and shortening of locking arm 250 and bending at joints 244 and 246. Load 14 is supported by the other side (not shown) of load support system 210, and force F₁ of load 14 is zero or negligible on the side of load support system 210 shown during swing phase. As user 12 enters swing phase, the knee flexes and lower link 242 may rotate in direction d₂ as user 12 picks up the leg. Lower link 242 acts on locking arm 250 at joint 244 to shorten locking arm 250, shown by force F₂. Piston rod 278 moves toward joint 254 with respect to chamber 274, thereby shortening locking arm 250. Fluid 276 flows through chamber 274 in the direction of the arrows within chamber 274. Fluid 276 flows through controllable valve 272, but does not flow through one-way check valve 270.

FIG. 13e corresponds to a mid-swing position, similar to a position shown in FIG. 11e. During swing phase, controllable valve 272 remains open. As user 12 flexes the hip and swings leg 62 forward, lower link 242 moves in the direction d₃ and pulls on locking arm 250, shown by force F₃. Piston rod 278 moves toward joint 244 with respect to chamber 274, thereby lengthening locking arm 250. Fluid 276 flows through chamber 274 in the direction of the arrows within chamber 274. Fluid 276 flows through both controllable valve 272 and one-way check valve 270.

In FIG. 13f, prior to heel strike, controllable valve 272 is closed in order to prepare for heel strike. Although controllable valve 272 is closed, one-way check valve 270 permits lengthening of locking arm 250. Therefore, if controllable valve 272 is closed prior to heel strike, the leg is still able to swing forward in a natural motion. Load support system 210 is locked and ready to immediately support load 14 upon heel strike. With damper 256 controlling locking arm 250 as a hydraulic lock, a passive structure provides support for load 14. Although damper 256 is controlled by actuator 258, damper 256 is passive in that damper 256 does not force user 12 into a particular gait motion. The function of actuator 258 to modulate controllable valve 272 is a low-power function. Thus, load support system 210 uses less power to operate and the size actuator 258 and the size of the battery or power source can be reduced. Due to the low power usage, load support system 210 can operate for a longer duration than active systems. By using a smaller battery and actuator, the weight of load support system 210 is reduced. Thus, load support system 210 provides the advantages of longer lasting load support with a lighter weight system, and more efficient gait for user 12 while carrying a supported load.

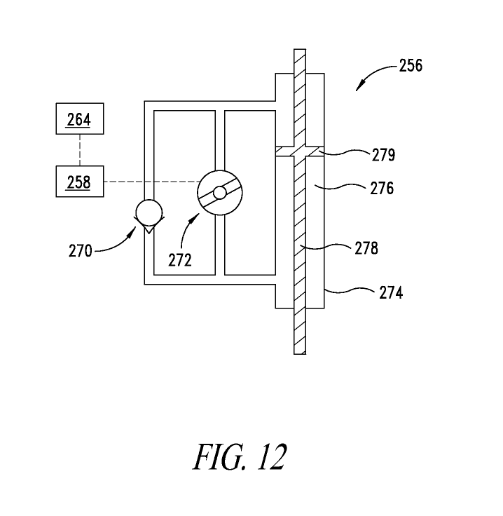

FIGS. 14a-14b show reference functions for use in a method of controlling a load support system. FIG. 14a shows graph of a method of controlling a damping of a load support system throughout a gait cycle. Line 290 illustrates an example of a reference function or lookup function used by control system 264 for selecting a position of controllable valve 272. The x-axis of the graph shows a gait cycle in terms of percentage of a single gait cycle for one leg of user 12 beginning with a heel strike. In one embodiment, the first 45% of the gait cycle represents stance phase, while the remaining 45%-100% of the gait cycle represents swing phase. The y-axis of the graph shows a position of controllable valve 272, with 1 representing a completely closed position and 0 representing a completely open position.

A heel strike is represented at zero on the x-axis (0% of the gait cycle) and marks the beginning of stance phase and the beginning of a gait cycle. Point A on line 290 represents a closed or locked position of controllable valve 272 in damper 256 at the beginning of a gait cycle. As the leg moves through stance phase, the leg naturally bends slightly. The natural position of load 14 is slightly lower to account for the slight knee bend. Load support system 210 accounts for the natural position of user 12 by opening controllable valve 272 at a controlled rate to allow load 14 to lower during stance. At approximately midway through stance phase, controllable valve 272 is opened slightly by actuator 258. Opening controllable valve 272 causes load 14 to compress locking arm 250 and load 14 is lowered at a rate controlled by the damping constant of damper 256. In one embodiment, a damping constant of damper 256 is modulated by a hydraulic lock and a valve, such as controllable valve 272, is opened approximately 10%. Point B on line 290 represents a partially open, such as 10% open, position of controllable valve 272 in damper 256 during mid-stance. The amount controllable valve 272 is opened is determined by the position of actuator 258. Opening controllable valve 272 partially but not completely results in a slight lowering of load 14 at a controlled rate, thereby positioning load 14 into a more natural and comfortable position for user 12 during mid-stance. The resistance or damping provided by damper 256 at point B permits a few degrees of knee flexion.

After load 14 is lowered, actuator 258 moves controllable valve 272 to a closed position until the end of stance phase. In the locked position, load support system 210 provides support for load 14 on the side in stance. Point C on line 290 represents a closed or locked position of controllable valve 272 in damper 256 at the end of stance. Between 40% and 50% of the gait cycle, actuator 258 moves controllable valve 272 to an open position. In one embodiment, controllable valve 272 is opened completely during swing phase. Point D on line 290 represents an open or unlocked position during the beginning of swing phase.

Controllable valve 272 is open until approximately the end of swing phase. In the unlocked position, load support system 210 allows unencumbered movement of the user's leg in swing phase. Point E on line 290 represents an open or unlocked position of controllable valve 272 in damper 256 during mid-swing. Between 90% and 100% of the gait cycle, actuator 258 moves controllable valve 272 again to a closed position in preparation for stance phase. Position F on line 290 represents a closed or locked position of controllable valve 272 in damper 256 prior to the end of swing phase of a gait cycle.

Controllable valve 272 may be modulated actuator 258 with other control patterns according to other factors including the size of the load, gait characteristics of user 12, the degree of damping desired, physical characteristics of user 12, geometry of the linkage assembly of load support system 210, and other factors. Accordingly, controllable valve 272 is modulated between open, closed, and any degree of damping in between fully open and fully closed. The modulated positions of controllable valve 272 may be selected to match predetermined gait characteristics, as determined by sensor 260 and control system 264. By controlling controllable valve 272 according to the user's gait cycle, load 14 is supported by load support system 210, and user 12 moves in a gait pattern that is similar to unloaded gait. Load support system 210 reduces musculoskeletal injuries caused by carrying heavy loads and improves metabolic efficiency while carrying heavy loads, thereby reducing the rate of a user's fatigue.

FIG. 14b shows graph of another method of controlling a damping of a load support system throughout a gait cycle. Line 292 illustrates an example of a reference function or lookup function used by control system 264 for selecting a position of controllable valve 272. Point A on line 292 represents a closed or locked position of controllable valve 272 in damper 256 at the beginning of a gait cycle. Point B on line 292 represents a closed or locked position of controllable valve 272 in damper 256 during mid-stance. Point C on line 292 represents a closed or locked position of controllable valve 272 in damper 256 at the end of stance. Point D on line 292 represents an open or unlocked position during the beginning of swing phase. Point E on line 292 represents an open or unlocked position of controllable valve 272 in damper 256 during mid-swing. Position F on line 292 represents a closed or locked position of controllable valve 272 in damper 256 at the end of swing phase of a gait cycle.

Line 294 represents an alternative reference function or lookup function used by control system 264 for selecting a position of controllable valve 272. Position H on line 294 represents controllable valve 272 in damper 256 being closed earlier in swing phase. Line 296 represents an alternative reference function or lookup function used by control system 264 for selecting a position of controllable valve 272. Point H on line 296 represents controllable valve 272 in damper 256 being closed later in swing phase. One-way valve 270 operates to permit the user to continue extending the leg after controllable valve 272 is closed. Therefore, controllable valve 272 can be closed at any point, for example in late-swing phase, prior to heel strike, and load support system 210 still allows mobility in the direction of leg extension and hip flexion. Thus, controllable valve 272 of damper 256 can be closed at point G, point F, or point H, or another point prior to heel strike without interfering with the user's leg swing.

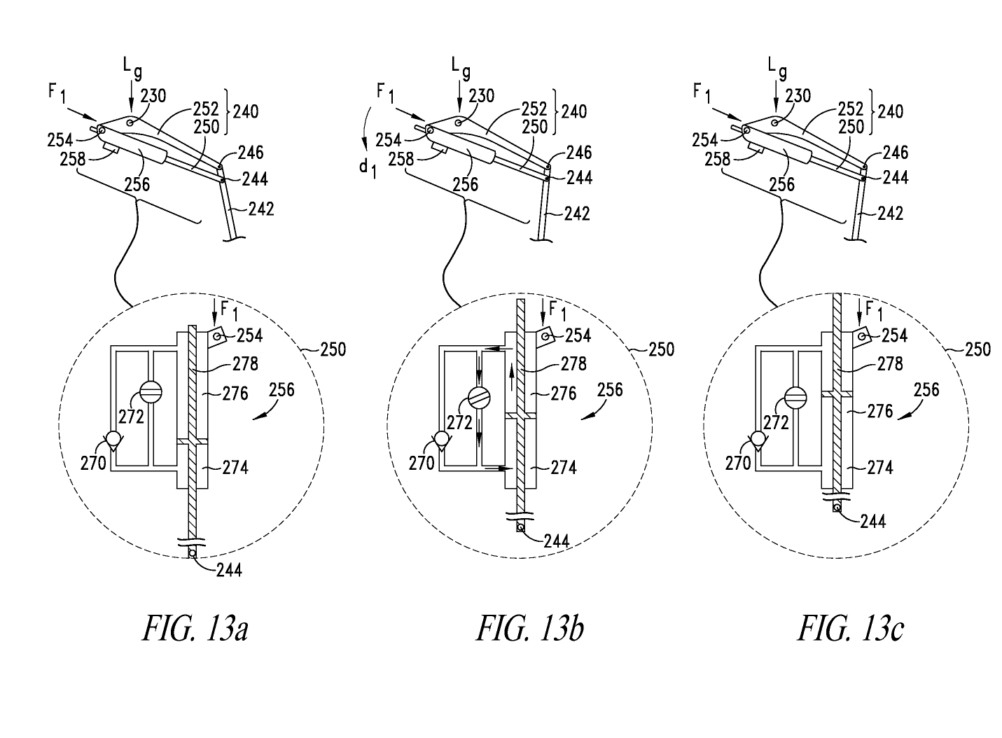

FIG. 15 shows a method of controlling a load support system. Information from sensors 60 or 260 on user 12 and load support system 10 or 210 are inputs for control system 64 or 264. In one embodiment, control system 264 relates an input from sensor or sensor 60 or 260 and outputs a command 302 to actuator 258 in order to control damper 256. Actuator 258 opens and closes controllable valve 272 in order to select the damping provided by damper 256 on locking arm 250. By controlling the damping of locking arm 250, the transfer of forces from load 14 through load support system 210 is optimized according to the information from sensor 60 or 260.

The method for controlling load support system 210 with control system 264 includes the steps of sensing or measuring 304 a physical state of user 12, processing 306 the sensed physical state using control system 264, generating 308 a command 302 for actuator 258, controlling 310 a position of actuator 258, and positioning 312 controllable valve 272 using actuator 258.

During the step of sensing 304, sensor 260 or a plurality of sensors 260 detect a physical characteristic or physical state of user 12, such as a kinematic state, a loading state, or a kinematic state and a loading state. Sensor 260 includes an accelerometer, vibrometer, rate gyro, potentiometer, pressure transducer, force transducer or load cell, inclinometer, or other sensor. The physical state or characteristic measured by sensor 260 includes a kinematic state, a loading state, or a kinematic state and a loading state of a mobile body. A kinematic state includes an angular position, linear position, linear velocity, angular velocity, linear acceleration, or angular acceleration associated with a mobile body. The kinematic state may be measured with reference to a fixed global frame or a frame fixed to any other mobile body. A loading state includes a moment or force experienced by the mobile body. The physical state measurement from sensor 260 is processed by control system 264. Sensing 304 includes a continuous measurement with sensor 260 to provide a continuous input into control system 264.

During the step of processing 306 the signal from sensor 260, information about the user's gait is determined. The physical state measurement from sensor 260 is filtered and conditioned to obtain information about the user's gait or terrain conditions or both, including the user's speed, stride length, percent of gait cycle, and terrain slope, such as an incline or decline. Other gait information may include joint angle, instantaneous center of rotation, and magnitude of force or moment. The gait information is further processed to obtain an output or command 302, which is transmitted to actuator 258.

During the step of generating 308 a command 302, the processed physical state measurement is input into a reference function, which may be derived from pre-recorded or pre-determined able-bodied gait data or gait activities. Gait activities include walking, running, traversing slopes or stairs, avoiding obstacles, and other similar activities. In one embodiment, the processed physical state measurement is compared with a recording or a calculation of able-bodied gait to match a desired gait activity. Command 302 is an output of control system 264 based on information from sensor 260 and predetermined gait information and is selected according to the desired damping of damper 256. Command 302 is used to control actuator 258 of damper 256. During the step of controlling 310 actuator 258, command 302 is transmitted to actuator 258 and used in the positioning 312 of controllable valve 272. Actuator 258 positions controllable valve 272 into an open, closed, or partially open position to accomplish the desired damping.

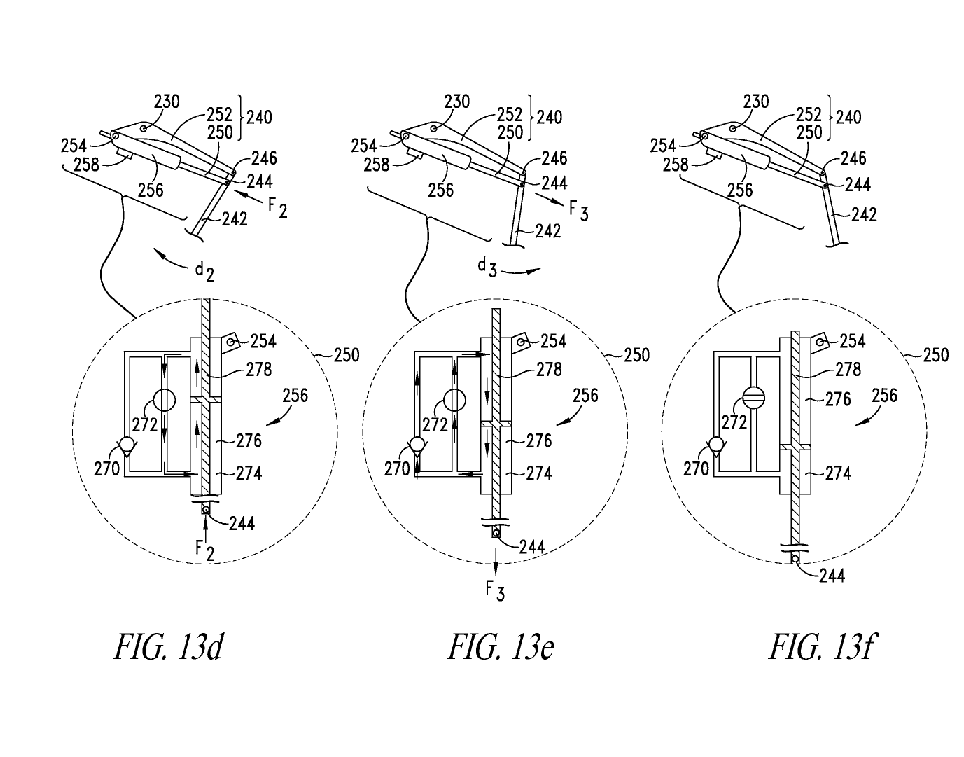

FIG. 16 shows additional detail of a method of controlling load support system 10 or 210. The step of sensing 304 a characteristic from sensor 260 generates sensor measurements or data 320. Data 320 from sensor 260 is processed using control system 264 to generate a command 302. In one embodiment, sensor data 320 undergoes steps of conditioning 322, transformation 324, and inputting 326 the conditioned and transformed data into a reference function 328 to generate 308 a reference command 302.

Sensor data or measurements 320 are conditioned using control system 264 to yield conditioned measurements.

Conditioning 322 is realized by any filtering method, including, but not limited to Kalman filtering, transfer function use, integration, pseudo integration, differentiation, pseudo differentiation, and amplification. Filtering methods are performed as many times as desired. In one embodiment, conditioning 322 includes amplification. Amplification may result from a gain of any nonzero number, including by a unity gain. In addition, conditioning 322 may also be realized by any combination and order of filtering, integration, differentiation, and amplification. Filtering is employed for multiple uses including reduction of noise in data 320, reduction of inaccuracies in data 320, or alteration of data 320. For example, alteration of data 320 is performed in a manner similar to integration or differentiation such that drift in numerical integration or noise in numerical differentiation is eliminated.

Conditioned data is transformed 324 using control system 264 to yield transformed data. The transformation 324 of conditioned data is generally described as changing coordinate systems to yield transformed data. Transformations 324 for changing coordinate systems include isometric transformations, non-isometric transformations, rotations, and dilations. Other types of transformations 324 include identity transformations, orthogonal projections, oblique projections, changes to other coordinate systems, and changes of scale. Other coordinate systems include polar coordinate systems, barycentric coordinate systems, and similar types of coordinate systems. Changes of scale include log scale or any other function of scale. Transformations 324 may include any transformation where the transformed data is a mathematical function of the conditioned data, or any combination in any order of transformations, projections, changes of coordinate system, changes of scale, or other mathematical function.

Data 320 may be processed using conditioning 322 and transformation 324 steps in any order, for example transforming prior to conditioning, conditioning prior to transforming. Additionally, data 320 may be conditioned or transformed more than one time. For example, data 320 may undergo conditioning and transformation followed by an additional conditioning step. Alternatively, data 320 may undergo either a conditioning step or a transformation step.

Conditioned data, transformed data, or conditioned and transformed data are used as inputs or arguments for one or more predetermined reference functions 328 and are used to calculate outputs or reference commands 302. Each reference function 328 is a function that relates conditioned and/or transformed data 320 as independent variables to the desired reference command 302 as a dependent variable. In one embodiment, reference function 328 is based on a predetermined function relating each input or combination of inputs to an output. In another embodiment, reference function 328 is made to match data from a combination of one or more gait activities such as walking, running, traversing slopes or stairs, obstacle avoidance, or similar activities. Reference function 328 yields reference command 302, which controls the output position for actuator 258 of load support system 210. In one embodiment, reference command 302 controls actuator 258 to match pre-determined able-bodied gait data from reference function 328.

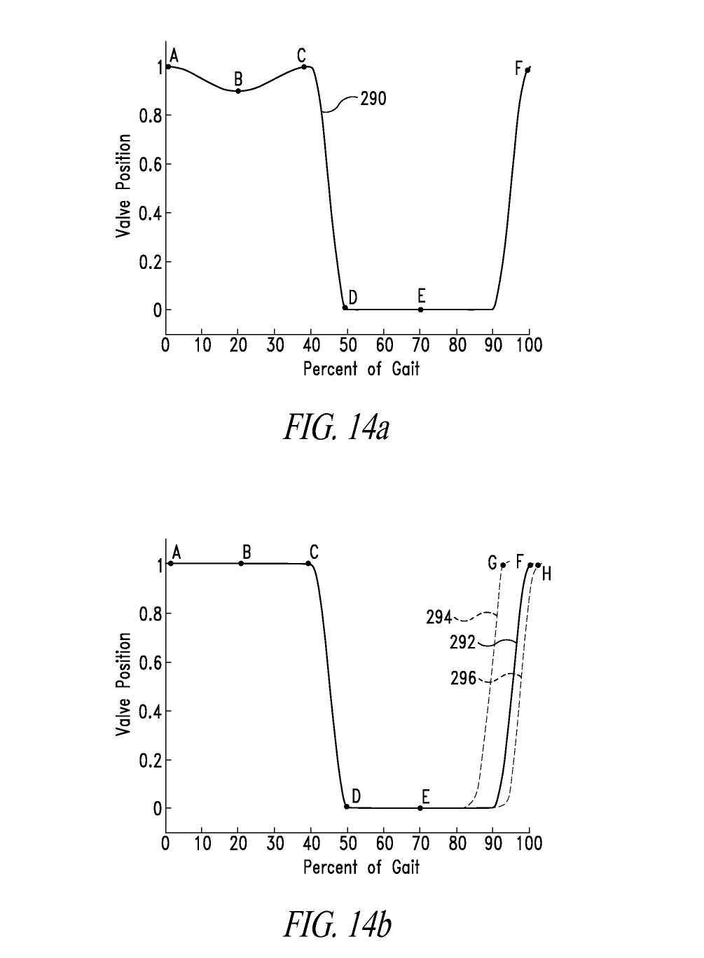

FIG. 17 shows a method of processing sensor data for controlling a load support system. Load support system 210 is controlled using control system 264. One or more sensors 260 are disposed on user 12 to measure one or more kinematic states of user 12. Sensor 260 provides a continuous sensor measurement S₁. In one embodiment, sensor measurement S₁ includes the angular velocity of the lower leg or shank of user 12 measured using a rate gyro. A rate gyro measures the angular velocity kinematic state of leg 62 and produces sensor measurement S₁ of the angular velocity of leg 62, a mobile body. Sensor measurement S₁ is conditioned by control system 264. In one embodiment, conditioning 322 of sensor measurement S₁ is realized by pseudo integration 340 and filtering 342. The step of pseudo integration 340 results in conditioned measurement 344. Conditioning 322 further includes the step of filtering 342 sensor measurement S₁. Filtering 342 of sensor measurement S₁ results in a conditioned measurement 346. In one embodiment, filtering 342 includes a first order filter used to eliminate noise in the signal from sensor 260. In another embodiment, conditioning 322 is realized by any filtering method, including, but not limited to Kalman filtering, transfer function use, integration, differentiation, amplification, and any combination of the filtering methods. Filtering 342 is performed as many times as desired. Filtering 342 is employed for multiple uses including reduction of noise, reduction of inaccuracies, or alteration of sensor measurement S₁.

Transformation 324 is performed on sensor measurement S₁ or conditioned measurements 344 and 346 resulting in transformed measurements 348. Transformation 324 includes changing coordinate system, such as by isometric, non-isometric transformations, rotations, dilations, or other suitable method. Other types of transformations include identity transformations, orthogonal projections, oblique projections, changes to other coordinate systems, and changes of scale. In addition, other coordinate systems include polar coordinate systems, barycentric coordinate systems, and similar types of coordinate systems. Changes of scale include log scale or another function of scale. In one embodiment, transformation 324 includes a step of converting the coordinate system of conditioned measurements 344 and 346 to modified polar coordinates, such as polar angle and polar radius.

After the step of transformation 324, transformed measurements 348 undergo an optional conditioning 350 step to obtain a conditioned transformed measurement. An additional conditioning step 350 may include filtering 352. Filtering 352 is performed as many times as desired. Filtering 352 is employed for multiple uses including reduction of noise, reduction of inaccuracies, or alteration of sensor measurement S₁, conditioned measurements 344 and 346, or transformed measurements 348. In one embodiment, conditioned transformed measurements resulting from conditioning 350 include a polar radius.

Sensor measurement S₁, conditioned measurements 344 and 346, or transformed measurements 348, or conditioned transformed measurements are used as arguments for reference functions 328. One or more reference functions 328 are used in generating 308 a reference command 302. Gait percent or gait progression indicates what stage user 12 is in a gait cycle. Stride length and gait percent are related to polar radius, and stride length is determined as a function of both gait percent and polar radius. In one embodiment, gait percent and stride length are used as arguments in reference function 328. In another embodiment, stride length is optional and gait percent is used as an argument in reference function 328.

Reference function 328 is based on a predetermined function relating each input to an output. Alternatively, reference function 328 is based predetermined gait information, such as able-bodied gait activities. Gait activities include walking, running, traversing slopes or stairs, avoiding obstacles, and other similar activities. A desired damping of load support system 210 is predetermined for each stride length and gait percent. A position for controllable valve 272 has a corresponding position for each damping constant of damper 256, and actuator 258 has a corresponding position for each valve position. Thus, reference function 328 correlates each input, such as gait percent, stride length, or both to a reference command 302, which correlates to a valve position. In one embodiment, reference function 328 includes a lookup table or lookup plot, such as the plots shown in FIGS. 14a-14b.

A position of actuator 258 is predetermined for each input through a predetermined reference function that is developed without prerecorded gait data. Alternatively, an output for each input is based on collection of able-bodied gait data and calculation of geometry for load support system 210. Based on the input, control system 264 looks up the desired actuator 258 position and generates reference command 302 to control the position of actuator 258, which positions controllable valve 272 to produce the appropriate damping in damper 256. In another embodiment, reference function 328 is a function that relates slope, stride length, and gait percent as independent variables to reference command 302 as a dependent variable. Actuator 258 position is determined by inputting slope, stride length, and gait percent into reference function 328. Reference function 328 is represented with a function that accepts inputs and that outputs a unique value for each combination of inputs.

Control system 264 includes a continuous function relating the position of actuator 258 to a measured signal. The continuous nature of control system 264 eliminates decision making by the system, if-then logic, and changes in state. In contrast to if-then logic controllers, control system 264 uses continuous measurements to continuously determine the user's movement and determine an actuator position to match the user's expected upcoming movement. By measuring kinematic or loading states, rather than simply choosing between stance and swing phase, control system 264 adapts to changes in gait. Control system 264 continuously calculates an output, rather than waiting on a gait event to trigger an output. Because the measured signal and output are related by a continuous function, the output is smooth. The measured signal is phase locked to the user's gait, and thus, the output of control system 264 is phase locked to the user's gait rather than time based. Because control system 264 is not time-based, control system 264 better adapts to changes in gait.

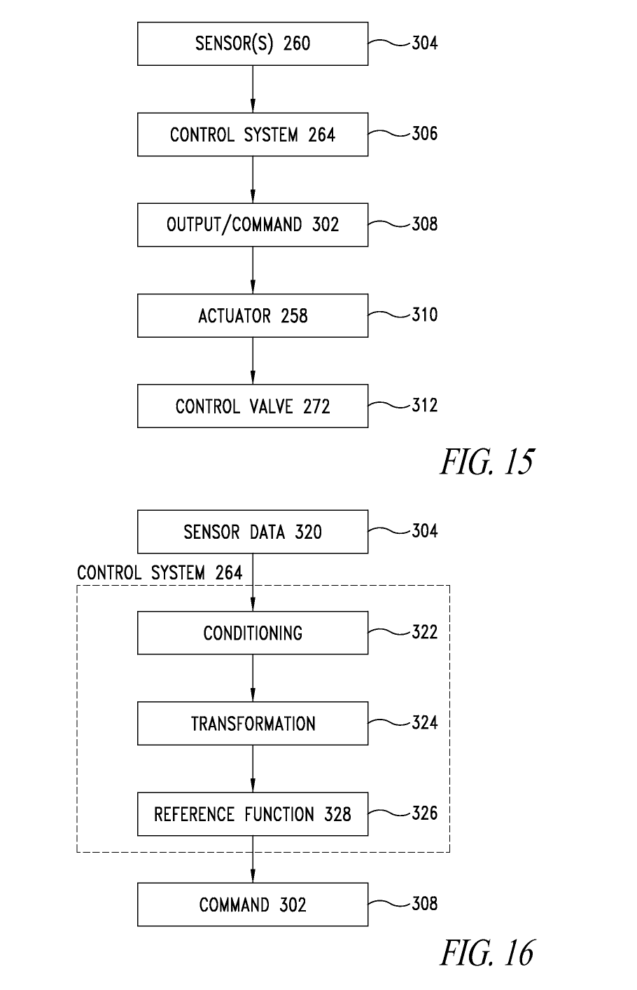

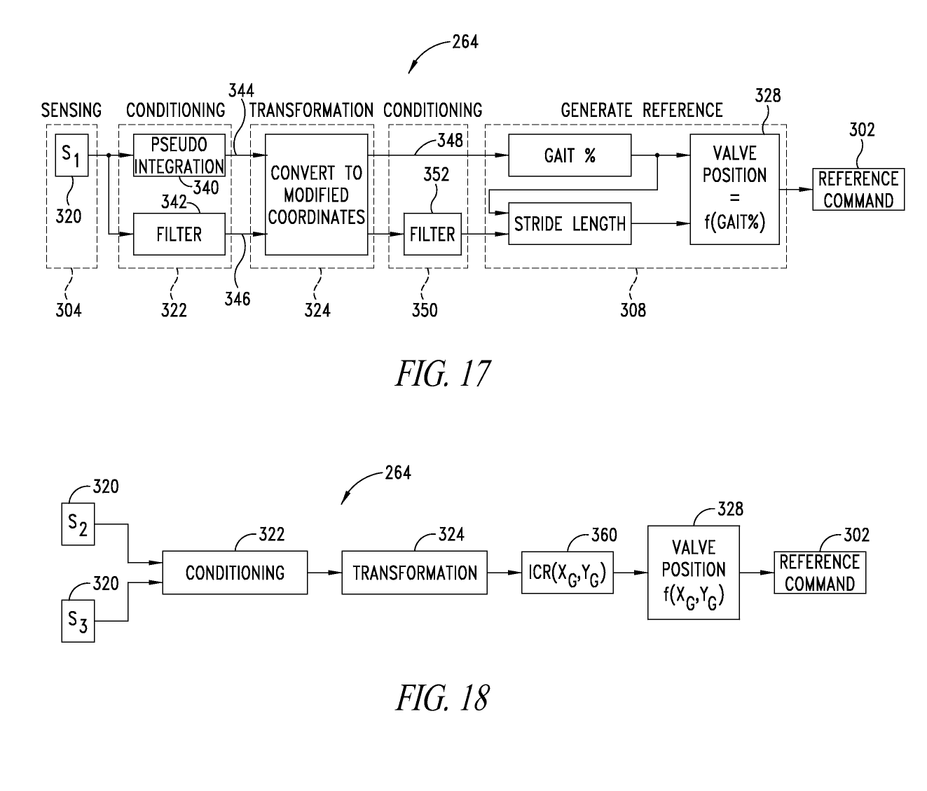

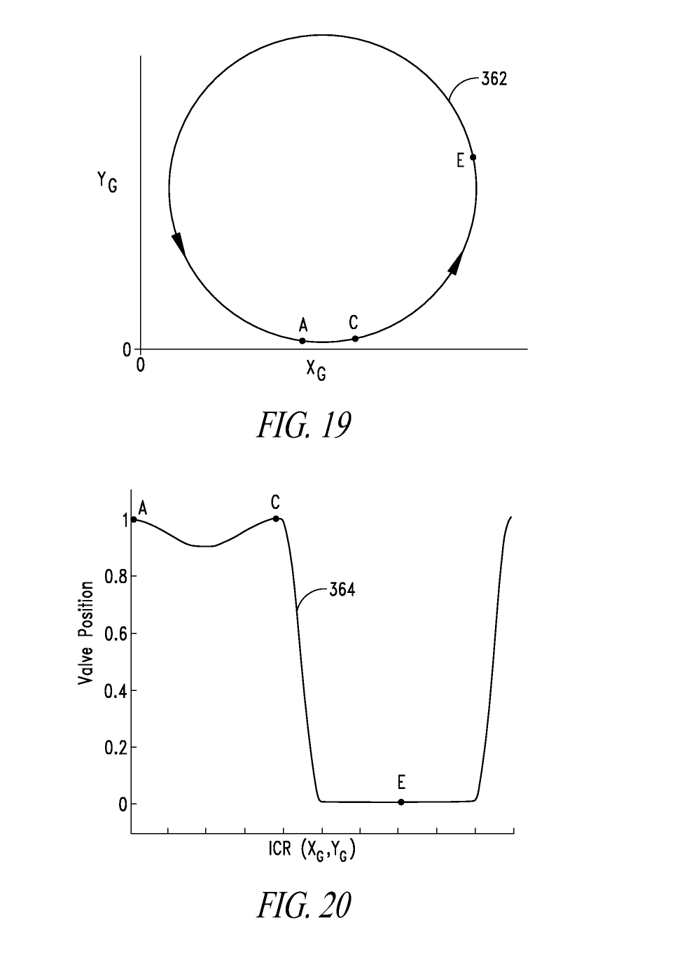

FIG. 18 shows an alternative method of processing sensor data for controlling a load support system. One or more sensors 260 are disposed on user 12 to measure one or more kinematic states of user 12. Sensors 260 provide continuous sensor measurements S₂ and S₃. In one embodiment, sensor measurement S₂ includes the angular velocity of foot 28 of user 12 measured using a rate gyro and sensor measurement S₃ includes the acceleration or angular acceleration of foot 28 measured using an accelerometer. Sensor measurements S₂ and S₃ undergo conditioning 322 and transformation 324 steps to obtain an instantaneous center of rotation (ICR) 360 of foot 28. Conditioning 322 of sensor measurements S₂ and S₃ is realized by any filtering method, including, but not limited to Kalman filtering, transfer function use, integration, pseudo integration, differentiation, pseudo differentiation, and amplification. Transformation 324 includes changing conditioned sensor measurements S₂ and S₃ into a global coordinate system (X_{G},Y_{G}) for determining an ICR 360 of foot 28 relative to the global coordinates, as shown in FIG. 19. Sensor measurements S₂ and S₃ are transformed to obtain an input for reference function 328. Reference function 328 is based on a predetermined function relating each input, such as ICR 360, to an output, such as a valve position. In one embodiment, reference function 328 includes a lookup table or lookup plot, as the plots shown in FIG. 20.

FIG. 19 shows a plot of an instantaneous rotation of the foot for use in controlling a load support system. The x-axis in FIG. 19 is a first coordinate X_{G} of ICR 360 represented in a selected global coordinate system. The y-axis in FIG. 19 is a second coordinate Y_{G} of ICR 360 represented in the global coordinate system. In one embodiment, an input for reference function 328 is an ICR 360 of foot 28 determined from sensor measurements S₂ and S₃, which were transformed into the global coordinate system. Line 362 represents an example of an ICR 360 of foot 28 relative to the global coordinate system throughout a single gait cycle. Each point on line 362 represents an input derived from sensor measurements S₂ and S₃. For example, point A on line 362 represents an ICR 360 of foot 28 at heel strike at the beginning of a gait cycle. Point C on line 362 represents an ICR 360 of foot 28 at push off. Point E on line 362 represents an ICR 360 of foot 28 during mid-swing. As user 12 moves through a gait cycle, the ICR of foot 28 moves relative to the global coordinate system. ICR 360 of foot 28 is input into reference function 328 to obtain a valve position for controllable valve 272.

FIG. 20 shows a reference function for use in a method of controlling a load support system. Line 364 illustrates an example of a reference function 328 or lookup function used by control system 264 for selecting a position of controllable valve 272 using ICR 360 as an input. For each point along line 362 from FIG. 19, there is a corresponding output along line 364 in FIG. 20. Reference function 328 relates each input ICR 360 to an output valve position. Point A on line 364 represents a closed or locked position of controllable valve 272 in damper 256 at the beginning of a gait cycle. Point C on line 364 represents a closed or locked position of controllable valve 272 in damper 256 at the end of stance. Point E on line 364 represents an open or unlocked position of controllable valve 272 in damper 256 during mid-swing. Thus, reference function 328 represented by line 364 is a look-up function that outputs a unique value for each combination of inputs.

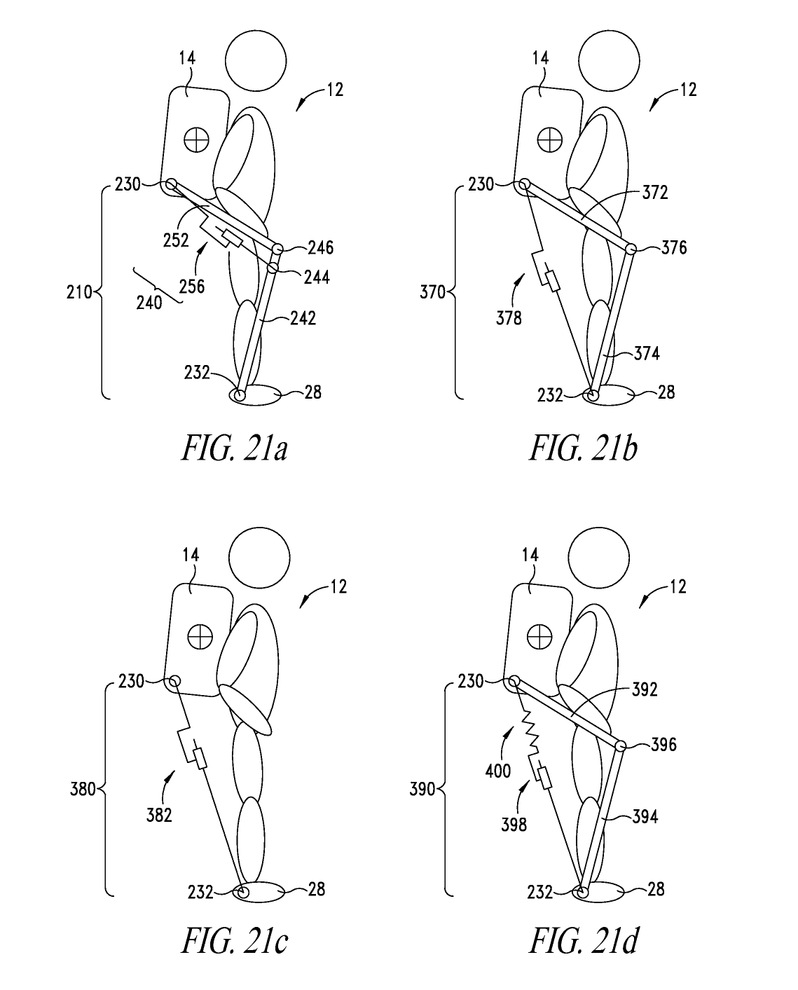

FIGS. 21a-21d show schematic diagrams of alternative load support systems. FIG. 21a shows a schematic of load support system 210 including a damper 256 coupled to upper link 240 and lower link 242. Damper 256 is coupled to any point along support link 252 and lower link 242 to provide support of load 14. The position of damper 256 along each of support link 252 and lower link 242 can be adjusted, while still spanning joint 246.

FIG. 21b shows a schematic of load support system 370 with a simplified representation of a linkage assembly, shown with upper link 372 rotationally coupled to lower link 374 at joint 376. Joint 376 operates as an effective knee joint of load support system 370. Load support system 370 includes a damper 378 coupled between load receptor point 230 and load transmission point 232 and spanning joint 376. Damper 378 is configured to control an angle or degree of bending at joint 376. Damper 378 may be disposed on joint 376, for example, using a rotary damper to directly control the angle or damping of joint 376.

FIG. 21c shows a schematic of load support system 380 represented simply by an effective damper 382 coupled between load receptor point 230 and load transmission point 232. While various linkage assemblies are disclosed, load support system 380 may include any linkage assembly that accomplishes the damping of effective damper 382.

FIG. 21d shows a schematic of load support system 390 with upper link 392 rotationally coupled to lower link 394 at joint 396. Joint 396 operates as an effective knee joint of load support system 390. Load support system 390 includes a damper 398 coupled between load receptor point 230 and load transmission point 232 and spanning joint 396. Load support system 390 further includes a compliant element 400 coupled in series with damper 298. Compliant element 400 is coupled between load receptor point 230 and load transmission point 232 and spanning joint 396. In one embodiment, compliant element 400 may be disposed along upper link 392 or lower link 394 to effectively operate in series with damper 398.

FIG. 22 shows a load support system including an adjustable load transmission point. Load support system 410 is similar to load support system 210 and includes an adjustable load transmission point 412, shown with adjustable positions 412a and 412b. The adjustable load transmission point 412, as described for load support system 410, may be incorporated into any of the load support systems disclosed herein, including load support system 210. Load support system 410 couples to load 14 at a load receptor point 230 and to footwear 226 at a load transmission point 412. In one embodiment, load transmission point 412 is coupled to footwear 226 by a footwear attachment 414. Footwear attachment 414 couples load transmission point 412 to footwear 226 through a linkage or linkage assembly that allows load transmission point 412 to actually or effectively adjust during gait to move a position or direction of the resulting force at load transmission point 412. The resulting force at load transmission point 412 is ultimately transferred through footwear attachment 414 and footwear 226 into the ground. Where load transmission point 412 is located behind the ankle joint, the weight of the transmitted load adds weight at the heel of foot 28. The weight at the heel of foot 28 pins or holds the user's heel down until user 12 is about to transfer to the opposite foot at toe-off. The heel pinning effect causes improper heel rise timing during gait. The heel pinning effect is corrected by adjusting load transmission point 412 during gait. For example, load transmission point 412 is positioned near the heel of foot 28 during heel strike and is repositioned near the ball of foot 28 during push-off. Positioning load transmission point 412 near the point of contact of foot 28 with the ground reduces the impact of load 14 on gait. A compliant element, such as compliant element 190, may also be incorporated into footwear attachment 414 or load support system 410 to apply a torsional stiffness at the user's ankle to assist with heel rise. For example, a tuned and adjusted spring at or near the ankle joint is used to provide proper timing of heel rise, and reduce pinning of the heel.

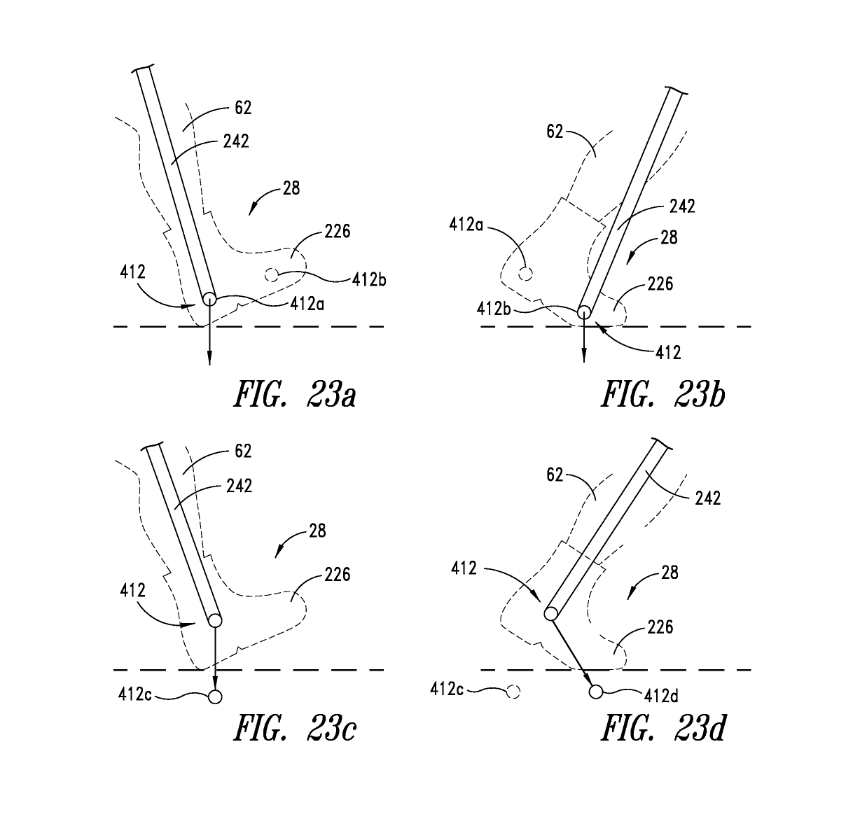

FIGS. 23a-23d show schematic diagrams of adjustable load transmission points. The force of load 14 at load transmission point 412 is physically moved or effectively redirected, or both, by a linkage assembly coupled to footwear attachment 414 or incorporated into footwear attachment 414. In FIGS. 23a-23b, a physical position of load transmission point 412 is adjusted during stance. FIG. 23a shows heel strike in early stance phase with the heel of foot 28 contacting the ground. Load transmission point 412 is shown in position 412a near the heel of foot 28. Position 412a reduces the impact of load 14 on the user's ankle joint during heel strike and improves gait efficiency. FIG. 23b shows push-off during late stance phase with the heel rising and the ball of foot 28 in contact with the ground. Load transmission point 412 is shown in position 412b near the ball of foot 28. Between heel strike and push-off, load transmission point 412 moves from the heel area to the forefoot area. The adjustment of load transmission point 412 is accomplished through a joint or linkage, which may be passive or actively controlled. Position 412b reduces the impact of load 14 on the user's ankle joint during push-off, thereby reducing heel pinning and improving gait efficiency.

In FIGS. 23c-23d, an effective position of load transmission point 412 is adjusted during stance. FIG. 23c shows heel strike in early stance phase with the heel of foot 28 contacting the ground. The force of load 14 at load transmission point 412 is directed toward the heel of foot 28, shown at position 412c. In one embodiment, position 412c represents an instantaneous center of load transmission point 412. Directing the force of load 14 towards position 412c reduces the impact of load 14 on the user's ankle joint during heel strike and improves gait efficiency. FIG. 23d shows push-off during late stance phase with the heel rising and the ball of foot 28 in contact with the ground. During stance, the direction of force of load 14 is adjusted or moved from back near the user's heel to a forward position near the ball of foot 28. Thus, between heel strike and push-off, load transmission point 412 moves forward from the heel area to the forefoot area. The force of load 14 at load transmission point 412 directed toward the ball of foot 28 is shown at position 412d. Directing the force of load 14 towards position 412d reduces the impact of load 14 on the user's ankle joint during push-off, thereby reducing heel pinning and improving gait efficiency.

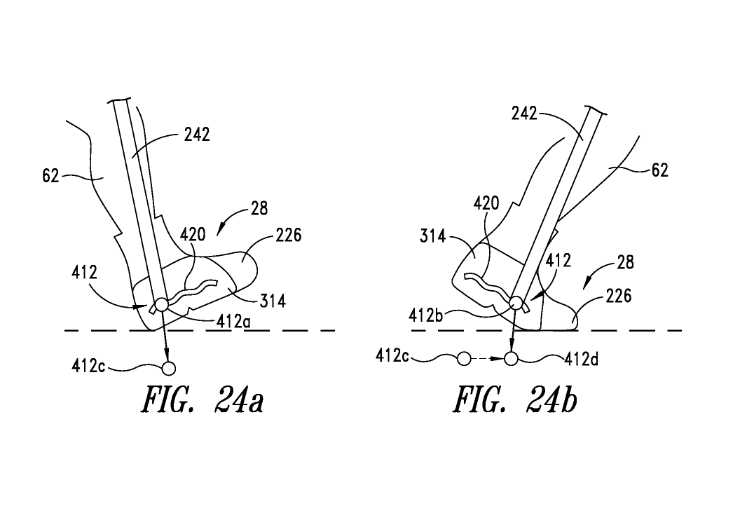

FIGS. 24a-24b show a schematic representation of a track guide for adjusting a load transmission point. In one embodiment, footwear attachment 414 includes guide or track 420 configured to move load transmission point 412. FIG. 24a shows heel strike in early stance phase with the heel of foot 28 contacting the ground. Load transmission point 412 is positioned on track 420 at position 412a near the heel of foot 28. In one embodiment, track 420 includes a curve that directs the force of load 14 at load transmission point 412 toward position 412c. Both the physical position 412a and direction of force of load transmission point 412 into position 412c reduce the impact of load 14 on the user's ankle joint during heel strike and improves gait efficiency. Load transmission point 412 moves along track 420 during stance. FIG. 24b shows push-off during late stance phase with the heel rising and the ball of foot 28 in contact with the ground. Load transmission point 412 is positioned on track 420 at position 412b near the ball of foot 28. In one embodiment, the curvature of track 420 at position 412b is different from a curvature of track 420 at position 412a. The different curvature results in a different instantaneous center of the force of load 14 at load transmission point 412. Therefore, track 420 directs the force of load 14 at load transmission point 412 toward position 412d. Both the physical position 412b and direction of force of load transmission point 412 into position 412d reduce the impact of load 14 on the user's ankle joint during push-off, thereby reducing heel pinning and improving gait efficiency.

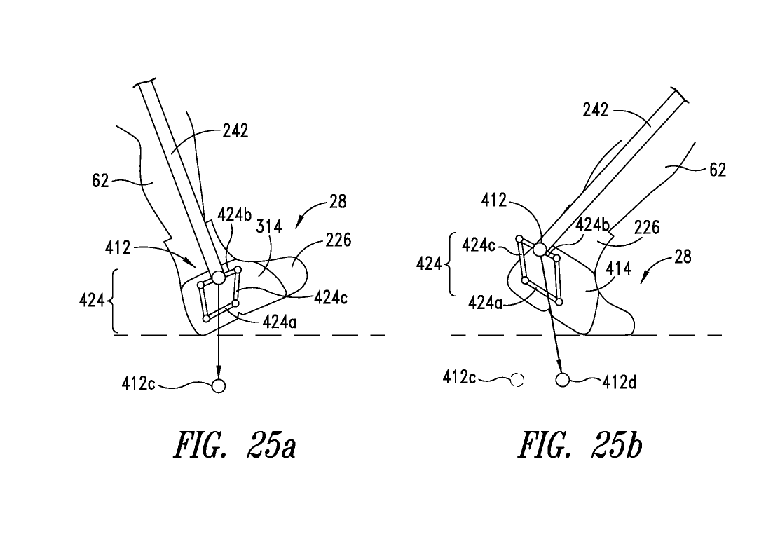

FIGS. 25a-25b show a schematic representation of four-bar mechanism for adjusting a load transmission point. In one embodiment, footwear attachment 414 includes four-bar linkage assembly 424 configured to adjust the direction of force of load 14 at load transmission point 412. Base link 424a of four-bar linkage assembly 424 is coupled to footwear attachment 414. Moveable link 424b of four-bar linkage assembly 424 is coupled to lower link 242 of load support system 210 at a joint. Moveable link 424b is coupled to base link 424a by two connecting links 424c at a plurality of joints. The joint between movable link 424b and lower link 242 and the joints between links 424a-424c of four-bar linkage assembly 424 may include revolute joints, prismatic joints, screw-type joints, spherical joints, or other joint types or a combination of joints. Four-bar linkage assembly 424 may further include compliant, damping, or active elements for controlling movement or rotation of the links.

FIG. 25a shows heel strike in early stance phase with the heel of foot 28 contacting the ground. Load transmission point 412 is positioned on moveable link 424b. Connecting links 424c position moveable link 424b with respect to base link 424a in order to direct the force of load 14 at load transmission point 412 towards position 412c. The force of load 14 at load transmission point 412 is directed toward the heel of foot 28, shown at position 412c. In one embodiment, position 412c represents an instantaneous center of rotation of four-bar linkage assembly 424. The direction of force of load transmission point 412 into position 412c reduces the impact of load 14 on the user's ankle joint during heel strike and improves gait efficiency. Between heel strike and push-off, moveable link 424b moves or rotates with respect to base link 424a to direct the force of load 14 at load transmission point 412 to a position closer to the forefoot. FIG. 25b shows push-off during late stance phase with the heel rising and the ball of foot 28 in contact with the ground. The force of load 14 at load transmission point 412 directed toward the ball of foot 28 is shown at position 412d. In one embodiment, position 412d represents an instantaneous center of rotation of four-bar linkage assembly 424. Directing the force of load 14 towards position 412d reduces the impact of load 14 on the user's ankle joint during push-off, thereby reducing heel pinning and improving gait efficiency.

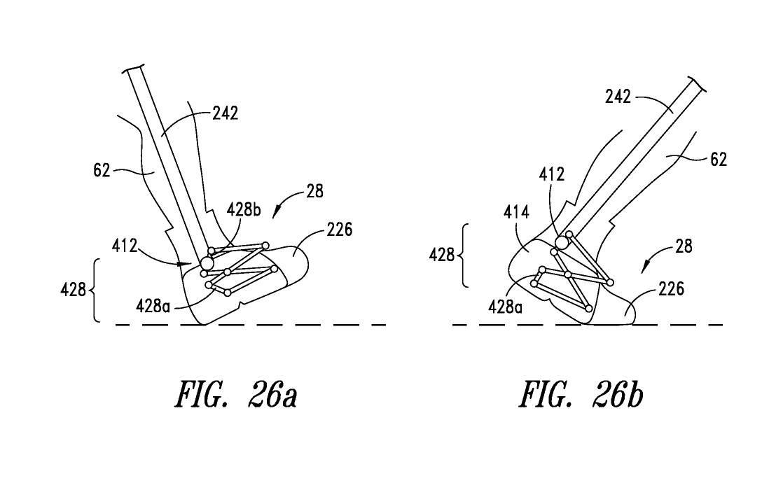

FIGS. 26a-26b show a schematic representation of a six-bar mechanism for adjusting a load transmission point. In one embodiment, footwear attachment 414 includes six-bar linkage assembly 428 configured to adjust the direction of force of load 14 at load transmission point 412. Base link 428a of six-bar linkage assembly 428 is coupled to footwear attachment 414. Moveable link 428b of six-bar linkage assembly 428 is coupled to lower link 242 of load support system 210 at a joint. Moveable link 428b is coupled to base link 428a by four connecting links 428c at a plurality of joints. The joint between movable link 428b and lower link 242 and the joints between links 428a-428c of six-bar linkage assembly 428 may include revolute joints, prismatic joints, screw-type joints, spherical joints, or other joint types or a combination of joints. Six-bar linkage assembly 428 may further include compliant, damping, or active elements for controlling movement or rotation of the links.

FIG. 26a shows heel strike in early stance phase with the heel of foot 28 contacting the ground. Load transmission point 412 is positioned on moveable link 428b. Connecting links 428c position moveable link 428b with respect to base link 428a in order to direct the force of load 14 at load transmission point 412 toward the heel of foot 28. In one embodiment, the direction of the force load transmission point 412 is determined by an instantaneous center of rotation of six-bar linkage assembly 428. The direction of force of load transmission point 412 into the heel of foot 28 reduces the impact of load 14 on the user's ankle joint during heel strike and improves gait efficiency. Between heel strike and push-off, moveable link 428b moves or rotates with respect to base link 428a to direct the force of load 14 at load transmission point 412 to a position closer to the ball of foot 28. FIG. 26b shows push-off during late stance phase with the heel rising and the ball of foot 28 in contact with the ground. The force of load 14 at load transmission point 412 directed through six-bar linkage assembly 428 toward the ball of foot 28. In one embodiment, the direction of the force load transmission point 412 is determined an instantaneous center of rotation of six-bar linkage assembly 428. Directing the force of load 14 towards the ball of foot 28 reduces the impact of load 14 on the user's ankle joint during push-off, thereby reducing heel pinning and improving gait efficiency.

Thus, gravitational load support systems are disclosed. While embodiments of the present invention have been shown and described, it will be apparent to those skilled in the art that many more modifications are possible without departing from the inventive concepts herein. Moreover, the testing examples described herein are representative only and are not to be construed as limiting. The invention, therefore, is not to be restricted except in the spirit of the following claims.

While one or more embodiments of the present invention have been illustrated in detail, the skilled artisan will appreciate that modifications and adaptations to those embodiments may be made without departing from the scope of the present invention as set forth in the following claims.

What is claimed:

1. A method of supporting a load carried by a user, comprising:
coupling a first link to the load;
coupling a second link to a first foot of the user, the second link pivotally coupled to the first link at a first joint;
disposing a first damping element between the first and second link;
disposing a first sensor on a first limb of the user;
measuring with the first sensor a physical characteristic of the first limb; and
selecting a damping constant of the first damping element based on the physical characteristic of the first limb to support the load.

2. The method of claim 1, further including increasing the damping constant of the first damping element based on the physical characteristic of the limb.

3. The method of claim 1, further including providing uni-directional damping with the damping element to support the load while permitting leg swing.

4. The method of claim 1, further including adjusting a position of the second link with respect to the first foot of the user during a gait cycle.

5. The method of claim 1, further including:
coupling a third link to a side of the user opposite the first link;
coupling a fourth link to a second foot of the user, the fourth link pivotally coupled to the third link; and
disposing a second damping element between the third and fourth link.

6. The method of claim 5, further including alternately supporting the load with the first damping element and the second damping element throughout a gait cycle.

7. A method of controlling a load support device, comprising:
coupling a link assembly to a load and to a first foot of a user;
disposing a first damping element spanning a joint of the link assembly;
disposing a first sensor on a first limb of the user;
measuring with the first sensor a physical characteristic of the first limb; and
selecting a damping constant of the first damping element based on the physical characteristic of the first limb to support the load.

8. The method of claim 7, further including conditioning and transforming the physical characteristic of the first limb to determine an instantaneous center of rotation of the first foot.

9. The method of claim 8, further including providing a reference function relating the instantaneous center of rotation of the first foot to a unique output.

10. The method of claim 9, further including inputting the instantaneous center of rotation of the first foot into the reference function to select the damping constant.

11. The method of claim 7, further including adjusting a position of the link assembly with respect to the first foot of the user during a gait cycle.

12. The method of claim 7, wherein measuring the physical characteristic further includes measuring an angular velocity and an acceleration of the first foot.

13. The method of claim 7, further including providing uni-directional damping with the first damping element to support the load while permitting leg swing.

14. A method of controlling a load support device, comprising:
coupling a first link assembly to a load and to a first foot of a user;
coupling a first damping element to the first link assembly;
disposing a first sensor on a first limb of the user;
measuring with the first sensor a physical characteristic of the first limb; and
modulating the first damping element based on the physical characteristic of the first limb.

15. The method of claim 14, further including conditioning and transforming the physical characteristic of the first limb to determine an instantaneous center of rotation of the first foot.

16. The method of claim 15, further including inputting the instantaneous center of rotation of the first foot into a reference function to determine an output command.

17. The method of claim 16, further including modulating the first damping element using the output command.

18. The method of claim 14, further including adjusting a position of the first link assembly with respect to the first foot of the user during a gait cycle.

19. The method of claim 14, further including:
coupling a second link assembly to a load and to a second foot of a user;
coupling a second damping element to the second link assembly; and
alternately supporting the load with the first damping element and the second damping element throughout a gait cycle.

20. A load support device, comprising:
a first link assembly configured to couple to a load and to a first foot of a user;
a first damping element coupled to the first link assembly between the load and the first foot;
a sensor coupled to a limb of the user and configured to determine a gait characteristic of the user; and
an actuator coupled to the first damping element, the actuator configured to open or close the first damping element based on the gait characteristic of the user.

21. The load support device of claim 20, wherein the first damping element includes a double acting piston configured to provide uni-directional damping.

22. The load support device of claim 20, wherein the actuator is configured to control a damping constant of the first damping element.

23. The load support device of claim 20, wherein the first link assembly supports the load when the first damping element is closed.

24. The load support device of claim 20, wherein the first link assembly couples to the first foot of a user by a footwear attachment configured to adjust a position of the load with respect to the first foot throughout a gait cycle.

25. The load support device of claim 20, further including:
a second link assembly configured to couple to the load and to a second foot of the user; and
a second damping element coupled to the second link assembly between the load and the second foot.
